(19) United States
(12) Patent Application Publication
(10) Pub. No.: US 2013/0308446 A1
(43) Pub. Date: Nov. 21, 2013

(54) COMMUNICATION SYSTEM, COMMUNICATION DEVICE, AND COMMUNICATION CONTROL METHOD

(71) Applicant: HITACHI, Ltd., Tokyo (JP)

(72) Inventors: Yuta MUTO, Tokyo (JP); Koji WATANABE, Tokyo (JP)

(73) Assignee: HITACHI, LTD., Tokyo (JP)

(21) Appl. No.: 13/893,737

(22) Filed: May 14, 2013

(30) Foreign Application Priority Data
May 16, 2012 (JP) 2012-112418

(51) Int. Cl. H04W 28/02

(52) U.S. Cl. CPC H04W 28/0289
USPC 370/230

(57) ABSTRACT

A congestion control target call is selected so as to be capable of reducing inequality or the like between services or users in consideration of characteristics such as the urgency of the service or the user. A communication system includes a server device, a terminal device which transmits and receives a packet to and from the server device, and a communication device which relays communication of a packet with the terminal device and a control method thereof. The communication device selects a call which is a congestion control target on the basis of a value indicating a priority selected as a congestion control target and/or a bandwidth or a packet communication traffic volume occupied by a service or user when congestion occurs in consideration of characteristics such as the urgency of the service or the user when the congestion of the communication system is detected or foreseen.

### CLAIM OF PRIORITY

The present application claims priority from Japanese patent application JP 2012-112418 filed on May 16, 2012, the content of which is hereby incorporated by reference into this application.

### BACKGROUND OF THE INVENTION

1. Field of the Invention

The present invention relates to a communication system, a communication device, and a communication control method, and particularly to a technique which applies congestion control or the like to a packet which is transmitted and received between a terminal and a service providing server.

2. Description of Background Art

In recent years, the study and the standardization on the 3.9th generation mobile communication system and the 4th generation mobile communication system have progressed as a method for realizing higher speed and higher quality of mobile wireless communication. The 3rd Generation Partnership Project (3GPP) which is a standardization group establishing standards of Long Term Evolution (LTE) which is one of the 3.9th generation mobile communication systems and LTE Advanced which is one of the 4th generation mobile communication systems establishes a Technical Specification (TS) as a specification of the standard.

The TS of 3GPP prescribes a specification for treating a call for a connection destination, requiring urgency such as the police or the fire fighting as an emergency call (IMS Emergency Session) so as to be differentiated from other calls. In addition, the TS of 3GPP prescribes a specification for treating a call which is connected to a special terminal or a preferential terminal by a government official or the like as a preferential call (Multimedia Priority Service) so as to be differentiated from other calls. Since the emergency call or the preferential call is a call requiring urgency due to characteristics of a service or a user, even in a case where Packet Data Network Gateway (hereinafter, indicated by P-GW) which is one of gateways in 3GPP detects congestion of a communication system including the gateway or other devices, it is necessary to perform congestion control so as to be differentiated from other calls.

As means for performing congestion control when the P-GW detects congestion of the communication system, restriction of the maximum bandwidth using a bandwidth control function or rejection of connection of a new call is considered.

The TS of 3GPP prescribes a specification, as a bandwidth control function of the P-GW, in which packet filtering is performed so as to correlate Quality of Service (QoS) conditions applied to each packet with a downlink packet (hereinafter, indicated by a DL packet) which is transmitted from a service providing server belonging to an Internet Protocol (IP) network to a terminal and an uplink packet (hereinafter, indicated by a UL packet) which is transmitted from the terminal to the service providing server, and bandwidth control is applied based on a result thereof. Here, the bandwidth control indicates, for example, packet transmission rate control or packet discarding. A notification of the above-described QoS condition is sent from a Policy and Charging Rule Function (PCFR) which is a node managing QoS and charging policy to a P-GW which is one of gateways in 3GPP, or the QoS condition is set in the P-GW in advance.

In addition, the TS of 3GPP prescribes a specification, as a function of the P-GW rejecting connection of a new call, in which connection of a new call is rejected by responding errors when a message indicating a request for connection of the new call such as Create Session Request is received.

3GPP TS23.401 V11.1.0, (2012-3), Technical Specification prescribes a specification regarding an emergency call or a preferential call, and a specification regarding bandwidth control or connection of a new call.

In addition, JP-A-2011-166237 discloses a technique in which a resource management device determines whether or not connection of a call is possible according to a priority of the call.

### SUMMARY OF THE INVENTION

In the congestion control function of a communication device such as the P-GW which is the same as in the above-described TS of 3GPP and JP-A-2011-166237, a call which is a congestion control target is selected based on characteristics, such as the urgency of a service or a user, only. Thereby, in a case where the urgency of services or users is the same, a call is equivalently selected as a congestion control target regardless of a bandwidth or a packet communication traffic volume occupied when congestion occurs. As a result, a service, which is rarely used or a user who rarely uses the service when the congestion occurs, occupies a bandwidth and is regulated by congestion control equivalently to a service or a user which causes congestion, and thereby a problem such as inequality between services or users may occur.

It is predicted that communication traffic rapidly increases due to a wider bandwidth of wireless connections and rapid widespread use of smart phones, and thus a probability increases that congestion of a communication system including a communication device such as a gateway occurs. In the current state, it is predicted that the problem such as inequality between services or users due to congestion control becomes serious. Similarly, there is a case where the above-described problem of inequality between services or users is concerned even in a fixed network due to the same congestion of a communication system.

An object of the present invention is to provide a communication system, a communication device, and a communication control method, capable of reducing inequality between services or users while selecting a congestion control target call in consideration of characteristics such as the urgency of a service or a user when congestion of a communication system occurs or congestion is foreseen in a wireless or wired communication system in light of the above-described problem.

According to the first solving means of the present invention, there is provided a communication system comprising:

a communication device that relays communication of a packet between a terminal device (MS) and other device, wherein

the communication device includes
a first table that stores an allocated bandwidth, the number of MSs, and a total allocated bandwidth for each call type and each service in relation to a plurality of calls connected to the communication device;
a second table that stores the number of connected MSs, a predefined weight value based on characteristics for each call type and each service, and a first index indicating a priority of a congestion control target, for each call type and each service in relation to a service which is selected as a congestion control target by the communication device; and
a processing unit that performs congestion control,

wherein

the processing unit receives a message indicating a connection request, or inputs a command regarding the congestion control, or detects a status or a failure regarding the congestion control,

the processing unit identifies a call type and a service by using the message, or the command, or the status or the failure, and increases the number of MSs of the call type and the service in the first table,

the processing unit calculates a total allocated bandwidth for each call type and each service by using a product of an allocated bandwidth and the number of MSs for each call type and each service on the basis of the first table, so as to be stored in the first table,

the processing unit refers to the first table and calculates a sum value by summing the total allocated bandwidth for a plurality of calls connected to the communication device, and determines whether or not the sum value exceeds a threshold value set in advance,

when the determination result is not equal to or not more than the threshold value, the processing unit determines that the communication device is in a congestion removal status, and, when the determination result is equal to or more than the threshold value, the processing unit determines that the communication device is in a congestion status,

the processing unit calculates the first index by using a product of the number of connected MSs and the weight value for each call type and each service on the basis of the second table, and preferentially selects a call type and a service as a congestion control target according to magnitude of the first index,

the processing unit preferentially performs the congestion control on one or a plurality of MSs corresponding to a call type and a service selected as a congestion control target, and

the processing unit obtains an allocated bandwidth and/or the number of MSs for each call type and each service from a result of performing the congestion control, and stores the allocated bandwidth and/or the number of MSs in the first table in correlation with the call type and the service.

According to the second solving means of the present invention, there is provided a communication device, which relays communication of a packet between a terminal device (MS) and other device, comprising:

a first table that stores an allocated bandwidth, the number of MSs, and a total allocated bandwidth for each call type and each service in relation to a plurality of calls connected to the communication device;

a second table that stores the number of connected MSs, a predefined weight value based on characteristics for each call type and each service, and a first index indicating a priority of a congestion control target, for each call type and each service in relation to a service which is selected as a congestion control target by the communication device; and

a processing unit that performs congestion control,

wherein

the processing unit receives a message indicating a connection request, or inputs a command regarding the congestion control, or detects a status or a failure regarding the congestion control,

the processing unit identifies a call type and a service by using the message, or the command, or the status or the failure, and increases the number of MSs of the call type and the service in the first table,

the processing unit calculates a total allocated bandwidth for each call type and each service by using a product of an allocated bandwidth and the number of MSs for each call type and each service on the basis of the first table, so as to be stored in the first table,

the processing unit refers to the first table and calculates a sum value by summing the total allocated bandwidth for a plurality of calls connected to the communication device, and determines whether or not the sum value exceeds a threshold value set in advance,

when the determination result is not equal to or not more than the threshold value, the processing unit determines that the communication device is in a congestion removal status, and, when the determination result is equal to or more than the threshold value, the processing unit determines that the communication device is in a congestion status,

the processing unit calculates the first index by using a product of the number of connected MSs and the weight value for each call type and each service on the basis of the second table, and preferentially selects a call type and a service as a congestion control target according to magnitude of the first index,

the processing unit preferentially performs the congestion control on one or a plurality of MSs corresponding to a call type and a service selected as a congestion control target, and

the processing unit obtains an allocated bandwidth and/or the number of MSs for each call type and each service from a result of performing the congestion control, and stores the allocated bandwidth and/or the number of MSs in the first table in correlation with the call type and the service.

According to the third solving means of the present invention, there is provided a communication control method using a communication system which comprises a communication device that relays communication of a packet between a terminal device (MS) and other device, wherein

the communication device includes
a first table that stores an allocated bandwidth, the number of MSs, and a total allocated bandwidth for each call type and each service in relation to a plurality of calls connected to the communication device;
a second table that stores the number of connected MSs, a predefined weight value based on characteristics for each call type and each service, and a first index indicating a priority of a congestion control target, for each call type and each service in relation to a service which is selected as a congestion control target by the communication device; and
a processing unit that performs congestion control,

wherein

the processing unit receives a message indicating a connection request, or inputs a command regarding the congestion control, or detects a status or a failure regarding the congestion control,

the processing unit identifies a call type and a service by using the message, or the command, or the status or the failure, and increases the number of MSs of the call type and the service in the first table,

the processing unit calculates a total allocated bandwidth for each call type and each service by using a product of an allocated bandwidth and the number of MSs for each call type and each service on the basis of the first table, so as to be stored in the first table,

the processing unit refers to the first table and calculates a sum value by summing the total allocated bandwidth for a plurality of calls connected to the communication device, and determines whether or not the sum value exceeds a threshold value set in advance,

when the determination result is not equal to or not more than the threshold value, the processing unit determines that the communication device is in a congestion removal status, and, when the determination result is equal to or more than

the threshold value, the processing unit determines that the communication device is in a congestion status, the processing unit calculates the first index by using a product of the number of connected MSs and the weight value for each call type and each service on the basis of the second table, and preferentially selects a call type and a service as a congestion control target according to magnitude of the first index,

the processing unit preferentially performs the congestion control on one or a plurality of MSs corresponding to a call type and a service selected as a congestion control target, and

the processing unit obtains an allocated bandwidth and/or the number of MSs for each call type and each service from a result of performing the congestion control, and stores the allocated bandwidth and/or the number of MSs in the first table in correlation with the call type and the service.

It is possible, according to the present invention, to provide a communication system, a communication device, and a communication control method, capable of reducing inequality between services or users while selecting a congestion control target call in consideration of characteristics such as the urgency of a service or a user when congestion of a communication system occurs or congestion is foreseen in a wireless or wired communication system in light of the above-described problem.

### BRIEF DESCRIPTION OF THE DRAWINGS

FIG. 1 is a conceptual diagram illustrating a functional configuration of a communication system according to an embodiment of the present invention.

FIG. 2 is a block diagram illustrating a configuration example of a communication system according to a first embodiment.

FIG. 3 is a functional block diagram illustrating an example of a gateway (GW) according to the first embodiment.

FIG. 4 is a block diagram of a memory unit of the GW according to the first embodiment.

FIG. 5 is a diagram illustrating an example of a table indicating information of the number of MSs and allocated bandwidth with call type and service units for all calls connected the GW according to the first embodiment.

FIG. 6 is a diagram illustrating an example of a table indicating information for determining a service which is selected as a congestion control target by the GW on the basis of a congestion control target weight value based on characteristics for each call type and each service and the number of MSs for each call type and each service when congestion occurs according to the first embodiment.

FIG. 7 is a diagram illustrating an example of a table indicating information for determining a user who is selected as a congestion control target by the GW on the basis of a congestion control target weight value based on characteristics for each user and a communication traffic volume for each user when congestion occurs according to the first embodiment.

FIG. 8 is a diagram illustrating an example of a table indicating information for determining a user who is selected as a congestion control target by the GW on the basis of a congestion degree of a base station (BS) which is used for communication by the user according to the first embodiment.

FIG. 9 is a diagram illustrating an example of a table indicating information for determining a user who is selected as a congestion control target by the GW on the basis of a congestion degree of a BS which is used for communication by the user according to the first embodiment.

FIG. 10 is a diagram illustrating an example of a table indicating information of a terminal (MS) connected to each BS according to the first embodiment.

FIG. 11 is a diagram illustrating an example of a table indicating wireless communication quality information of each MS according to the first embodiment.

FIG. 12 is a diagram illustrating an example of a table indicating information for determining a selection type of a congestion control target user and a method of performing congestion control when selected as a congestion control target for each call type and each service according to the first embodiment.

FIG. 13 is a diagram illustrating a selection type of a congestion control target user according to the first embodiment.

FIG. 14 is a diagram illustrating an example of a table indicating information of an MS connected for each call type and each service according to the first embodiment.

FIG. 15 is a diagram illustrating an example of a process in which the GW detects congestion of the GW itself according to the first embodiment.

FIG. 16 is a diagram illustrating an example of a process in which the GW selects a congestion control target call and performs congestion control according to the first embodiment.

FIG. 17 is a diagram illustrating an example of a table indicating information for determining a congestion status on the basis of a threshold value of an allocated bandwidth sum value according to the first embodiment.

FIG. 18 is a diagram illustrating an example of a table indicating information of a table for determining a selection type of a congestion control target user and a method of performing congestion control when selected as a congestion control target for each congestion status according to the first embodiment.

FIG. 19 is a diagram illustrating an example of a table indicating information for determining a corresponding congestion status for each event of congestion occurrence or congestion foreseeing according to the first embodiment.

FIG. 20 is a diagram illustrating another example of a process in which the GW detects congestion of the GW itself according to the first embodiment.

FIG. 21 is a diagram illustrating another example of a table indicating information for determining a selection type of a congestion control target user and a method of performing congestion control when selected as a congestion control target for each call type and each service according to the first embodiment.

### DETAILED DESCRIPTION OF THE INVENTION

Hereinafter, an embodiment of the present invention will be described with reference to the drawings. Prior to the embodiment being described, an outline thereof will be described.

A representative embodiment of the present invention is as follows. That is, there are provided a communication system including a server device connected to a network, a terminal device which is connected to the network and transmits and receives a packet to and from the server device, and a communication device which relays communication of the packet, and a control method thereof. The communication device detects congestion of the communication system, specifies a service or a user to which a packet received by the communication device belongs, and selects a service or a user which is a congestion control target on the basis of both a weight value which is determined by an operator and indicates a priority selected as a congestion control target in consideration of characteristics such as the urgency of the service or the user and a value which indicates a bandwidth or a packet communication traffic volume occupied by the service or the user when the congestion occurs.

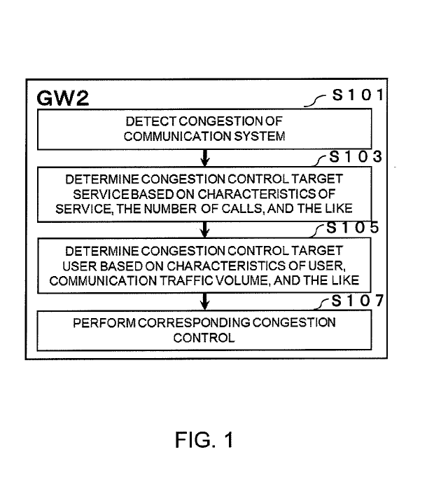

FIG. 1 is a functional configuration diagram illustrating an outline of a communication system according to an embodiment of the present invention. In FIG. 1, when a gateway (hereinafter, indicated by GW) 2 detects congestion of the communication system (S101), the GW 2 determines a service which is a congestion control target on the basis of, for example, characteristics such as the urgency for each service, and the number of MSs connected to each service when the congestion occurs (S103).

In addition, the GW 2 determines a user who is a congestion control target on the basis of characteristics such as the urgency for each user, and a communication traffic volume of each user when the congestion occurs (S105).

The GW 2 performs congestion control on the basis of the selection result of the congestion control target call (S107).

With the communication system, a call which is selected as a congestion control target determined by various conditions can be selected on the basis of a bandwidth or a packet communication traffic volume occupied by a service or a user when congestion occurs, and thereby a service or a user causing the congestion by occupying a bandwidth undergoes bandwidth restriction or regulation of call connection by congestion control in preference to a service which is almost not used or a user who almost does not use the service when the congestion occurs. Thereby, it is possible to reduce inequality between services or users in the congestion control.

### First Embodiment

Hereinafter, the first embodiment of the present invention will be described sequentially with reference to the drawings.

1. System and Device

System Configuration

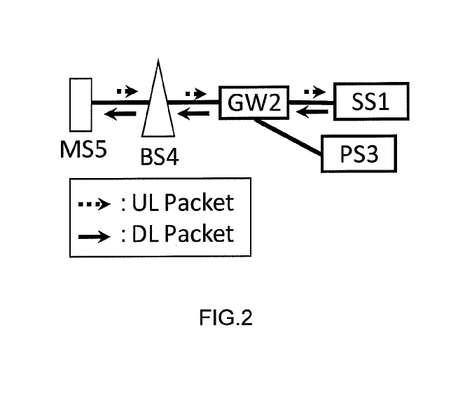

FIG. 2 is a diagram illustrating a configuration example of a communication system according to the first embodiment.

The communication system of the first embodiment includes a terminal (a mobile station; hereinafter, indicated by an MS) 5 which performs wireless communication or wired communication with a base station (hereinafter, indicated by a BS) 4, a GW 2 which communicates with the MS 5 via the BS 4, a service providing server (a service server; hereinafter, indicated by an SS) 1 which communicates with the GW 2, and a policy server (hereinafter, indicated by a PS) 3 which communicates with the GW 2.

Here, the PS 3 may be mounted in the same device as the GW 2. In addition, the BS 4 may be omitted, and, in this case, the MS 5 communicates with the GW 2 without using the BS 4, and the GW 2 communicates with the MS 5 without using the BS 4.

In addition, each of the constituent elements of the communication system of the present embodiment is shown singly in FIG. 2, but, practically, any number of constituent elements is used. For example, the communication system of the present embodiment may include a plurality of MSs 5 which communicate with a single BS 4, further, may include a plurality of BSs 4, still further, may include a plurality of PSs 3, still further, may include a plurality of GWs 2, and, still further, may include a plurality of SSs 1.

Device Configuration: GW 2

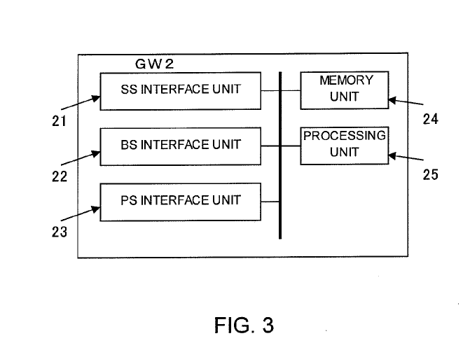

FIG. 3 shows a functional block of a configuration example of the GW 2 used in the present embodiment. The GW 2 includes, for example, an SS interface unit 21, a BS interface unit 22, a PS interface unit 23, a memory unit 24, and a processing unit 25.

The SS interface unit 21 is an interface with the SS 1. The GW 2 performs transmission and reception of an IP packet with the SS 1 by using the SS interface unit 21.

The BS interface unit 22 is an interface with the BS 4. The GW 2 performs transmission and reception of an IP packet with the BS 4 by using the BS interface unit 22. In a case of a communication system in which the BS 4 is omitted, the GW 2 directly performs transmission and reception of an IP packet with the MS 5 without using the BS 4, by using the BS interface unit 22.

The PS interface unit 23 is an interface with the PS 3. The GW 2 performs transmission and reception of an IP packet with the PS 3 by using the PS interface unit 23. In a case of a communication system in which the PS 3 is omitted, this interface unit may be omitted.

The memory unit 24 stores and manages transmitted and received IP packets, and information such as addresses of the connected SS 1, BS 4 and PS 3 as necessary.

In addition, the interface units 21 to 23 of the GW 2 described above are collectively referred to as interface units of the GW 2 or network interface units in some cases. These interface units are connected to the memory unit 24 and the processing unit 25 via an internal bus.

The processing unit 25 includes, for example, a Central Processing Unit (CPU). The processing unit 25 manages information held in the memory unit 24, and executes a variety of programs stored in the memory unit 24 so as to perform various processes, for example, a IP packet transmission and reception process such as building or analysis of an IP packet, detection of congestion, determination of a congestion control target call, and congestion control.

In addition, although description of a detailed internal configuration will be omitted, the constituent elements SS 1, PS 3, BS 4 and MS 5 other than the GW 2 forming the communication system of the present embodiment also include network interface units, a memory unit, and a processing unit therein in the same manner. The processing unit is realized by a CPU in the same manner as the processing unit 25 of the GW 2, and executes and processes a functional program appropriate for the PS 3.

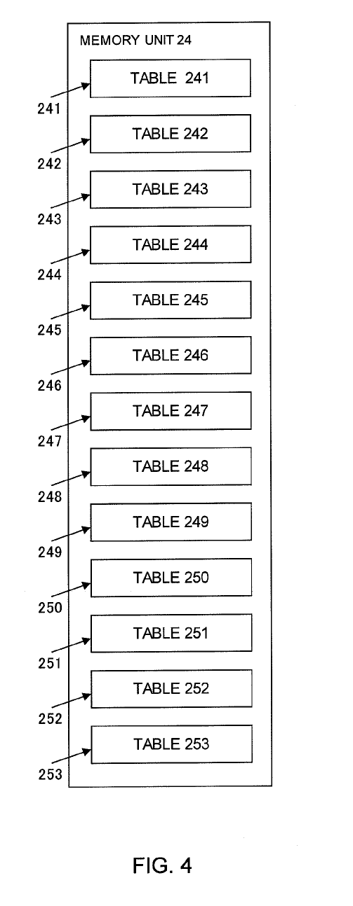

FIG. 4 is a block diagram illustrating a configuration example of the memory unit of the GW 2 according to the present embodiment.

The memory unit 24 holds tables 241 to 253, for example, as shown in FIG. 4.

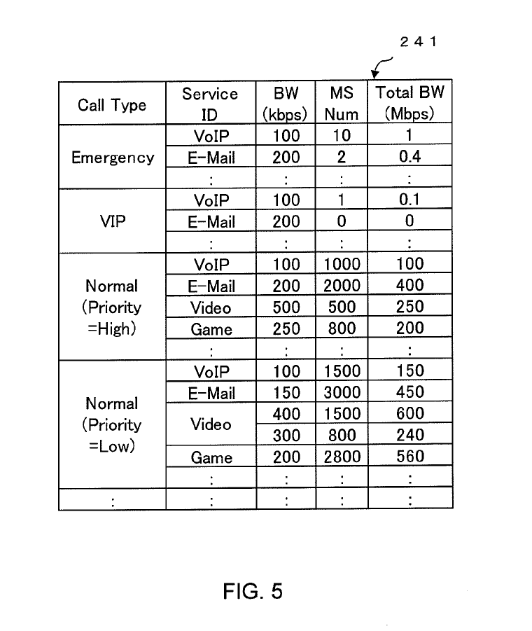

The table 241 is used for the GW 2 to determine a congestion status of the GW 2 and indicates information of the number of MSs and an allocated bandwidth with the call type and service units for all calls connected to the GW 2. By using the table 241, it is possible to manage information such as a call type, an identifier of a service, an allocated bandwidth for each call type and each service, the number of connected MSs for each call type and each service, and a total allocated bandwidth for each call type and each service. In addition, details of the table 241 will be described later (refer to FIG. 5).

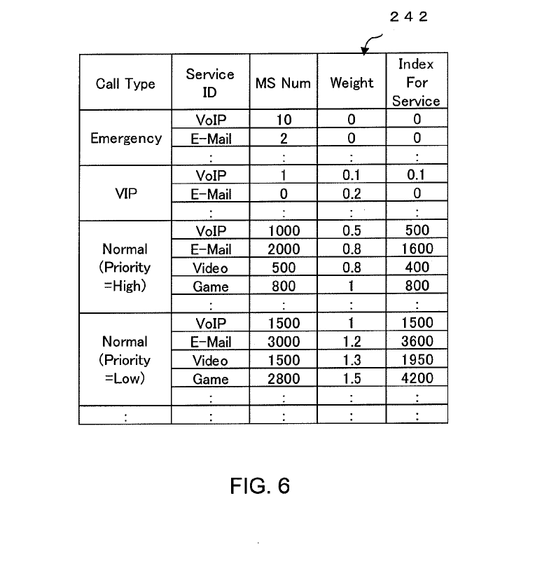

The table 242 indicates information for determining a service which is selected as a congestion control target by the GW 2 on the basis of a congestion control target weight value based on characteristics for each call type and each service and the number of MSs for each call type and each service when congestion occurs. By using the table 242, it is possible to manage information such as a call type, an identifier of a service, the number of connected MSs for each call type and each service, a weight value based on characteristics for each call type and each service, and a congestion control target index for each call type and each service. In addition, details of the table 242 will be described later (refer to FIG. 6).

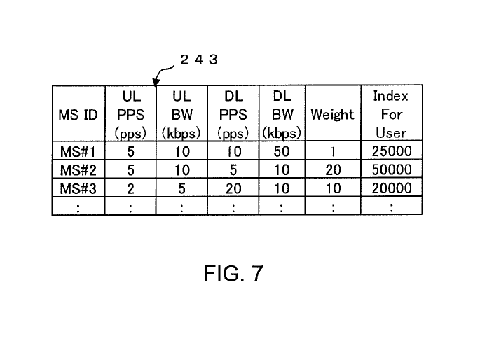

The table 243 indicates information for determining a user who is selected as a congestion control target by the GW 2 on the basis of a congestion control target weight value based on characteristics for each user and a communication traffic volume for each user when congestion occurs. By using the table 243, it is possible to manage information such as an identifier of the MS 5, the number of packets to be transmitted per second of UL packets for each MS, the number of bytes to be transmitted per second of UL packets for each MS, the number of packets to be transmitted per second of DL packets for each MS, the number of bytes to be transmitted per second of DL packets for each MS, a weight value based on characteristics of a user, and a congestion control target index for each user. In addition, details of the table 243 will be described later (refer to FIG. 7).

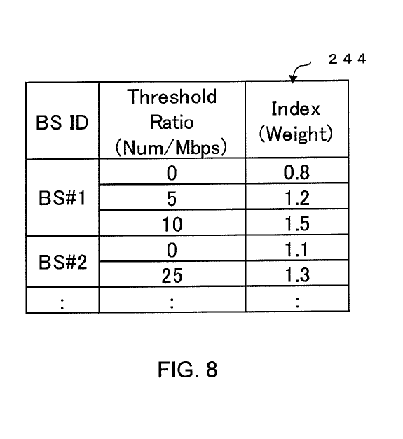

The table 244 indicates information for determining a user who is selected as a congestion control target by the GW 2 on the basis of a congestion degree of the BS 4 which is used for communication by the user. By using the table 244, it is possible to manage information such as an identifier of the BS 4, a threshold value of a ratio of a cell throughput of the BS 4 and the number of MSs 5 connected to the BS 4, and a weight value based on a congestion degree of the BS 4. In addition, details of the table 244 will be described later (refer to FIG. 8).

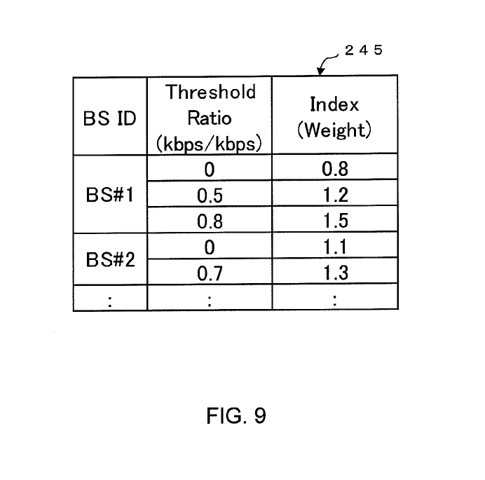

The table 245 indicates information for determining a user who is selected as a congestion control target by the GW 2 on the basis of a congestion degree of the BS 4 which is used for communication by the user. By using the table 245, it is possible to manage information such as an identifier of the BS 4, a threshold value of a ratio of a cell throughput of the BS 4 and a total transmission throughput of MSs 5 connected to the BS 4, and a weight value based on a congestion degree of the BS 4. In addition, details of the table 245 will be described later (refer to FIG. 9).

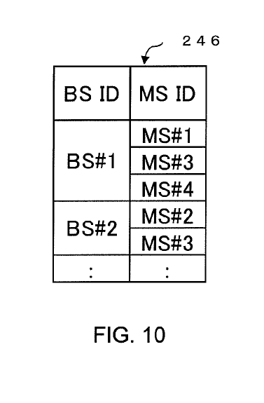

The table 246 indicates information of the MS 5 connected to each BS 4. By using the table 246, it is possible to manage information such as an identifier of the BS 4, and an identifier of the MS 5 connected to each BS 4. In addition, details of the table 246 will be described later (refer to FIG. 10).

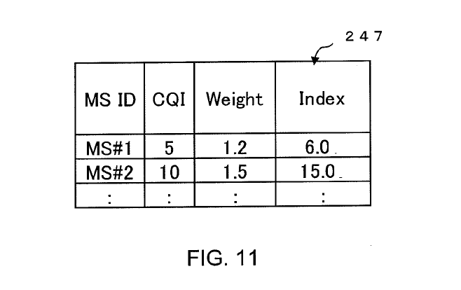

The table 247 indicates wireless communication quality information of each MS 5. By using the table 247, it is possible to manage information such as an identifier of the MS 5, wireless reception strength of each MS 5, and a weight value based on wireless communication quality of the BS 4. In addition, details of the table 247 will be described later (refer to FIG. 11).

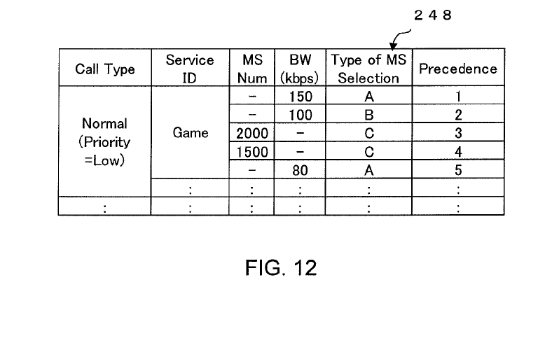

The table 248 indicates information for determining a selection type of a congestion control target user and a method of performing congestion control when selected as a congestion control target for each call type and each service. By using the table 248, it is possible to manage information such as a call type, an identifier of a service, an upper limit value of the number of connected MSs, a limitation bandwidth, a selection type of a congestion control target user, and Precedence. In addition, details of the table 248 will be described later (refer to FIG. 12).

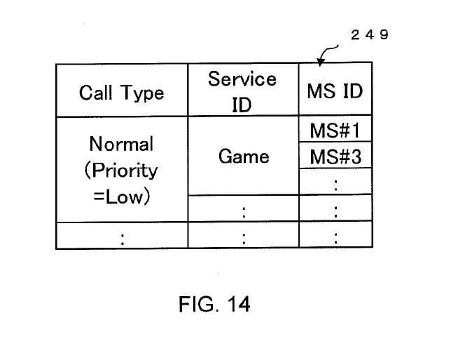

The table 249 indicates information of an MS connected for each call type and each service. By using the table 249, it is possible to manage information such as a call type, an identifier of a service, and an identifier of an MS. In addition, details of the table 249 will be described later (refer to FIG. 14).

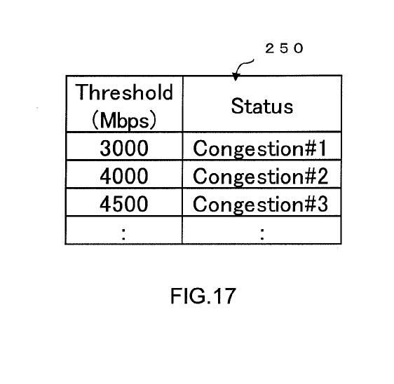

The table 250 indicates information for determining a congestion status on the basis of a threshold value of an allocated bandwidth sum value. By using the table 250, it is possible to manage information such as a threshold value of an allocated bandwidth sum value and a congestion status. In addition, details of the table 250 will be described later (refer to FIG. 17).

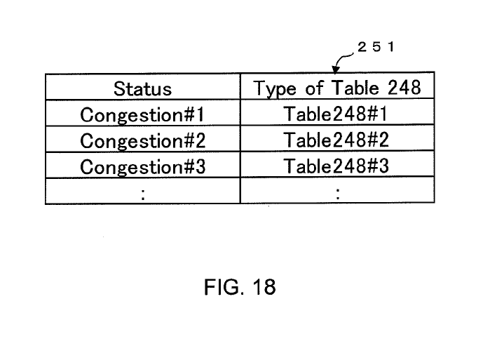

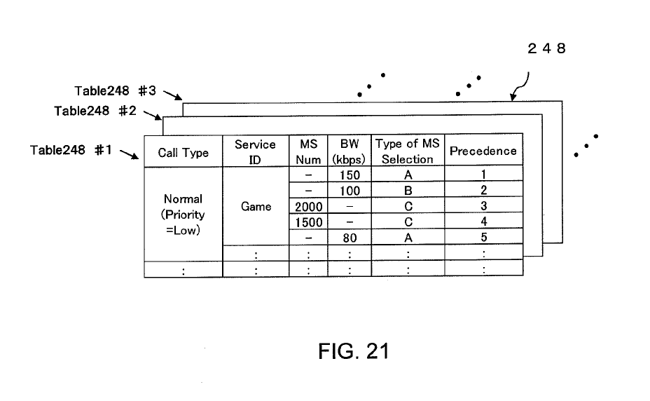

The table 251 indicates information of a table for determining a selection type of a congestion control target user and a method of performing congestion control when selected as a congestion control target for each congestion status. By using the table 251, it is possible to manage information such as a congestion status and the type of table 248 which is used (particularly, refer to a case where a plurality of tables 248 are held as in FIG. 21 described later). In addition, details of the table 251 will be described later (refer to FIG. 18).

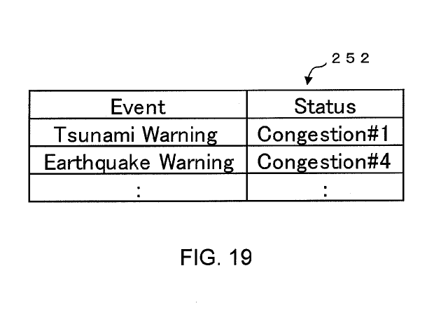

The table 252 indicates information for determining a corresponding congestion status for each event of congestion occurrence or congestion foreseeing. By using the table 252, it is possible to manage information such as an event of congestion occurrence or congestion foreseeing and a congestion status. In addition, details of the table 252 will be described later (refer to FIG. 19).

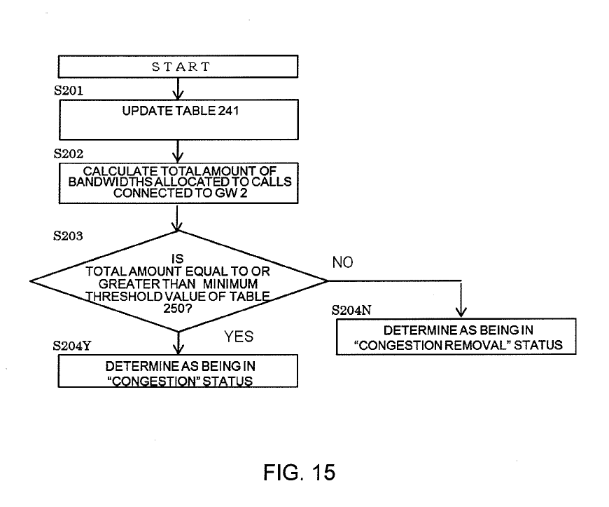

The table 253 includes lists such as a plurality of various lists used for a process of determining a call type and a list of MSs having a call connected to a congestion device. The GW 2 may refer to appropriate list, and determine a call type on the basis of a message. In addition, details thereof will be described later through description of FIGS. 5 and 15.

Details of Each Table

FIG. 5 shows the table 241 as an example of information held in the memory unit 24 of the GW 2 according to the present embodiment. The table 241 is used for the GW 2 to determine a congestion status of the GW 2 itself and indicates information of the number of MSs and an allocated bandwidth with the call type and service units for all calls connected to the GW 2.

The table 241 stores, for example, a call type (Call Type), an identifier of a service (Service ID), an allocated bandwidth (BW) for each call type and each service, the number of MSs (MS Num) for each call type and each service, and a total allocated bandwidth (Total BW) for each call type and each service.

The call type is a parameter for identifying the type of call, and is differentiated into, for example, an emergency call (Emergency), a preferential call (VIP), a normal call (Normal (Priority=High)) with a high priority, a normal call (Normal (Priority=Low)) with a low priority, and the like. The emergency call can be discriminated, for example, by determining whether or not an identifier of the SS 1 of a connection destination of a call such as Access Point Name (APN) in the TS of 3GPP is registered in a list (the table 253) of values indicating emergency agencies such as the police and the fire fighting. The list (the table 253) of identifiers of the SSs 1 indicating emergency agencies such as the police and the fire fighting may be set in the GW 2 in advance by an operator, or the list may be set in the PS 3 in advance by the operator and the GW 2 may acquire only a call type as a result of inquiring of the PS 3. The preferential call can be discriminated, for example, by determining whether or not an identifier indicating the MS 5 which requests connection of a call such as International Mobile Subscriber Identity ('MSI) in the TS of 3GPP is registered in a list (the table 253) of values allocated to special terminals or preferential terminals of government officials and the like. The list (the table 253) of identifiers of the MSs 5 allocated to special terminals of government officials and the like may be set in the GW 2 in advance by an operator, or the list may be set in the PS 3 in advance by the operator and the GW 2 may acquire only a call type as a result of inquiring of the PS 3. A priority of the normal call can be discriminated, for example, by determining whether or not an identifier indicating the MS 5 which requests connection of a call is registered in a list (the table 253) of values allocated to normal terminals with a high priority such as a terminal for business use only or a subscriber of high price plan. The list (the table 253) of identifiers of the MSs 5 allocated to normal terminals with a high priority may be set in the GW 2 in advance by an operator, or the list may be set in the PS 3 in advance by the operator and the GW 2 may acquire only a call type as a result of inquiring of the PS 3.

The identifier of a service is a parameter indicating characteristics of a service requested by call connection, such as QoS Class Identifier (QCI) in the TS of 3GPP. The identifier of a service may be managed in a numerical value such as QCI, may be managed in the service name (for example, VoIP, E-Mail, Video, Game, and the like) as in the example of FIG. 5, or may be managed in any character string.

The allocated bandwidth for each call type and each service is a parameter indicating a bandwidth allocated to a service for each MS. The GW 2 may perform a bandwidth restriction on an UL packet or a DL packet so as not to exceed this value. In addition, the GW 2 may manage this value separately in UL and DL.

The number of connected MSs for each call type and each service is a parameter indicating the number of MSs which are connected to each service for each call type via the GW 2. In addition, in a case where a bandwidth allocated to each MS becomes different by performing congestion control on some MSs even between MSs belonging to the same call type and service, for example, as in the call type “Normal (Priority=Low)” and the service “Video” of FIG. 5, the number of connected MSs may be managed for each allocated bandwidth.

The total allocated bandwidth for each call type and each service is a product of an allocated bandwidth for each call type and each service and the number of connected MSs for each call type and each service. For example, in the example of FIG. 5, this value is integrated for all call types and services, and thereby a total amount of bandwidths allocated to the respective call types and services by the GW 2 is obtained.

In addition, an initial value of the information included in the table 241 may be set in the GW 2 in advance, or may be set by a message which is received by the GW 2 from the PS 3 or the BS 4 or a command which is input by an operator. Further, this information may be updated by a message which is received by the GW 2 from the PS 3 or the BS 4 or a command which is input by the operator.

FIG. 6 shows the table 242 as an example of the information held in the memory unit 24 of the GW 2 according to the present embodiment. The table 242 indicates information for determining a service which is selected as a congestion control target by the GW 2 on the basis of a congestion control target weight value based on characteristics for each call type and each service and the number of MSs for each call type and each service when congestion occurs.

The table 242 stores, for example, a call type (Call Type), an identifier of a service (Service ID), the number of MSs (MS Num) for each call type and each service, a weight value (Weight) based on characteristics for each call type and each service, and a congestion control target index (Index for Service) for each call type and each service.

The call type, the identifier of a service, and the number of connected MSs for each call type and each service are the same parameters as the parameters included in the above-described table 241.

The weight value based on characteristics for each call type and each service is a parameter which is determined based on characteristics such as the urgency for each call type and each service. This value is determined by an operator, for example, based on his/her own congestion control policy, and a smaller value is set to a call type and a service which are desired to be excluded from a congestion control target.

The congestion control target index for each call type and each service is a parameter used as an index indicating which call type and service are preferentially selected as a congestion control target. For example, in the example of FIG. 6, the index is obtained using a product of the number of connected MSs for each call type and each service and the weight value based on characteristics for each call type and each service.

In addition, an initial value of the information included in the table 242 may be set in the GW 2 in advance, or may be set by a message which is received by the GW 2 from the PS 3 or the BS 4 or a command which is input by an operator. Further, this information may be updated by a message which is received by the GW 2 from the PS 3 or the BS 4 or a command which is input by the operator.

FIG. 7 shows the table 243 as an example of the information held in the memory unit 24 of the GW 2 according to the present embodiment. The table 243 indicates information for determining a user who is selected as a congestion control target by the GW 2 on the basis of a congestion control target weight value based on characteristics for each user and a communication traffic volume for each user when congestion occurs.

The table 243 stores, for example, an identifier of the MS 5 (MS ID), the number of packets to be transmitted per second of UL packets (UL PPS) for each MS, the number of bytes to be transmitted per second of UL packets (UL BW) for each MS, the number of packets to be transmitted per second of DL packets (DL PPS) for each MS, the number of bytes to be transmitted per second of DL packets (DL BW) for each MS, a weight value (Weight) based on characteristics of a user, and a congestion control target index (Index for User) for each user.

The identifier of an MS is a parameter for uniquely identifying each MS 5 in the GW 2, such as IMSI in the TS of the 3GPP.

The number of packets to be transmitted per second of UL packet for each MS is obtained by dividing the number of packets to be transmitted of UL packets for each MS, measured by the GW 2, by the number of seconds for measurement. A value of which time is used may be defined, for example, based on a policy of an operator, may be obtained from an integrated value of the month unit from the last month when congestion was detected, or may be obtained from an integrated value for five minutes immediately before congestion is detected.

The number of bytes to be transmitted per second of UL packets for each MS, the number of packets to be transmitted per second of DL packets for each MS, and the number of bytes to be transmitted per second of DL packets for each MS may also be calculated from a value measured by the GW 2 according to a definition based on the policy of the operator in the same manner as the above-described number of packets to be transmitted per second of UL packets for each MS. Here, the number of bytes of a packet may be, for example, the number of bytes of an entire packet or the number of bytes of only a payload excluding a header portion. Further, the information of the number of transmitted UL packets, the number of transmitted UL bytes, the number of transmitted DL packets, and the number of transmitted DL bytes per second for each MS may use only some values for calculation of a congestion control target index for each user depending on a congestion control policy set by the operator, and, in this case, information which is not necessary for the calculation may be omitted.

The weight value based on characteristics of a user is a parameter which is determined based on characteristics such as the urgency for each user. This value is determined by an operator, for example, based on his/her own congestion control policy, and a smaller value is set in a user who is desired to be excluded from a congestion control target.

The congestion control target index for each user is a parameter used as an index indicating which user is preferentially selected as a congestion control target. For example, in the example of FIG. 7, the index is obtained using a product of a product of the number of transmitted UL packets, the number of transmitted UL bytes, the number of transmitted DL packets, and the number of transmitted DL bytes per second for each MS, and the weight value based on characteristics of a user. In addition, the number of transmitted UL packets, the number of transmitted UL bytes, the number of transmitted DL packets, and the number of transmitted DL bytes per second for each MS may use only some values for calculation of a congestion control target index for each user depending on a congestion control policy set by the operator.

In addition, an initial value of the information included in the table 243 may be set in the GW 2 in advance, or may be set by a message which is received by the GW 2 from the PS 3 or the BS 4 or a command which is input by an operator. Further, this information may be updated by a message which is received by the GW 2 from the PS 3 or the BS 4 or a command which is input by the operator.

FIG. 8 shows the table 244 as an example of the information held in the memory unit 24 of the GW 2 according to the present embodiment. The table 244 indicates information for determining a user who is selected as a congestion control target by the GW 2 on the basis of a congestion degree of the BS 4 which is used for communication by the user.

The table 244 stores, for example, an identifier of the BS 4 (BS ID), a threshold value (Threshold Ratio (Num/Mbps)) of a ratio of a cell throughput of the BS 4 and the number of MSs 5 connected to the BS 4, and a weight value (Weight) based on a congestion degree of the BS 4.

The identifier of the BS 4 is a parameter for identifying each BS 4 connected to the GW 2.

The threshold value of a ratio of a cell throughput of the BS 4 and the number of MSs 5 connected to each BS 4 is a parameter for obtaining a weight value based on a congestion degree of the BS 4. The cell throughput of the BS 4 may be acquired from the BS 4 in the events of periodical acquisition using a timer, or may be acquired from the BS 4 in the events of detecting that a cell throughput of the BS 4 is greater than an upper limit threshold value which is set in advance or is smaller than a lower limit threshold value. In addition, the number of MSs 5 connected to the BS 4 may be acquired from the BS 4 in the events of periodical acquisition using a timer, or may be acquired from the BS 4 in the events of detecting that the number of MSs 5 connected to the BS 4 is greater than an upper limit threshold value which is set in advance or is smaller than a lower limit threshold value. A notification of the acquired cell throughput of the BS 4 and the number of MSs 5 connected to the BS 4 may be sent to the GW 2 by using a message which is transmitted from the BS 4 to the GW 2, a message from a server which acquires a statistical item, or the like. The processing unit 25 of the GW 2 may calculate a ratio of the acquired cell throughput of the BS 4 and the number of MSs 5 connected to the BS 4, and may update a value set in the table 244 to the calculated value when it is determined that this value is different from the value set in the table 244.

The weight value based on a congestion degree of the BS 4 is a parameter indicating a weight value based on a congestion degree of the BS 4 used for communication by a user when the user who is a congestion control target is selected. This value is determined by an operator, for example, based on his/her own congestion control policy, and a smaller value is set in a case which is desired to be excluded from a congestion control target. For example, a greater weight value is set to a more congested BS 4, and thereby an MS 5 which uses the congested BS 4 is preferentially selected as a congestion control target so as to reduce a congestion degree of the BS 4.

In addition, an initial value of the information included in the table 244 may be set in the GW 2 in advance, or may be set by a message which is received by the GW 2 from the PS 3 or the BS 4 or a command which is input by an operator. Further, this information may be updated by a message which is received by the GW 2 from the PS 3 or the BS 4 or a command which is input by the operator.

FIG. 9 shows the table 245 as an example of the information held in the memory unit 24 of the GW 2 according to the present embodiment. The table 245 indicates information for determining a user who is selected as a congestion control target by the GW 2 on the basis of a congestion degree of the BS 4 which is used for communication by the user.

The table 245 stores, for example, an identifier of the BS 4 (BS ID), a threshold value (Threshold Ratio (kbps/kbps)) of a ratio of a cell throughput of the BS 4 and a total transmission throughput regarding UL packets of the MS 5 connected to the BS 4, and a weight value (Weight) based on a congestion degree of the BS 4.

The identifier of the BS 4 is a parameter for identifying each BS 4 connected to the GW 2.

The threshold value of a ratio of a cell throughput of the BS 4 and a total transmission throughput regarding UL packets of the MS 5 connected to the BS 4 is a parameter for obtaining a weight value based on a congestion degree of the BS 4. The cell throughput of the BS 4 may be acquired from the BS 4 in the events of periodical acquisition using a timer, or may be acquired from the BS 4 in the events of detecting that a cell throughput of the BS 4 is greater than an upper limit threshold value which is set in advance or is smaller than a lower limit threshold value. In addition, the total transmission throughput of the MS 5 connected to the BS 4 may be acquired from the BS 4 in the events of periodical acquisition using a timer, or may be acquired from the BS 4 in the events of detecting that the total transmission throughput of the MS 5 connected to the BS 4 is greater than an upper limit threshold value which is set in advance or is smaller than a lower limit threshold value. A notification of the acquired cell throughput of the BS 4 and the total transmission throughput of the MS 5 connected to the BS 4 may be sent to the GW 2 by using a message which is transmitted from the BS 4 to the GW 2, a message from a server which acquires a statistical item, or the like. The processing unit 25 of the GW 2 may calculate a ratio of the acquired cell throughput of the BS 4 and the total transmission throughput of the MS 5 connected to the BS 4, and may update a value set in the table 245 to the calculated value when it is determined that this value is different from the value set in the table 245.

The weight value based on a congestion degree of the BS 4 is a parameter indicating a weight value based on a congestion degree of the BS 4 used for communication by a user when the user who is a congestion control target is selected. This value is determined by an operator, for example, based on his/her own congestion control policy, and a smaller value is set in a case which is desired to be excluded from a congestion control target. For example, a greater weight value is set in a more congested BS 4, and thereby an MS 5 which uses the congested BS 4 is preferentially selected as a congestion control target so as to reduce a congestion degree of the BS 4.

In addition, an initial value of the information included in the table 245 may be set in the GW 2 in advance, or may be set by a message which is received by the GW 2 from the PS 3 or the BS 4 or a command which is input by an operator. Further, this information may be updated by a message which is received by the GW 2 from the PS 3 or the BS 4 or a command which is input by the operator.

FIG. 10 shows the table 246 indicating information of the MS 5 connected to the BS 4 as an example of the information held in the memory unit 24 of the GW 2 according to the present embodiment. The table 246 stores, for example, an identifier of the BS 4 (BS ID) and an identifier of the MS 5 (MS ID).

The identifier of the BS 4 is a parameter for identifying the BS 4 used for communication by the MS 5.

The identifier of the MS 5 is a parameter for identifying the MS 5 which uses each BS 4 for communication. In addition, in a case where a single MS 5 establishes connection with a plurality of BSs 4, the same identifier of the MS 5 may be registered for different BSs 4.

In addition, this information may be updated by a message which is received by the GW 2 from the PS 3 or the BS 4.

FIG. 11 shows the table 247 as an example of the information held in the memory unit 24 of the GW 2 according to the present embodiment. The table 247 indicates wireless communication quality information of each MS 5.

The table 247 stores, for example, an identifier of the MS 5 (MS ID), wireless reception strength of each MS 5 (CQI), and a weight value (Weight) based on wireless communication quality of the BS 4.

The identifier of the MS 5 is a parameter for uniquely identifying each MS 5 in the GW 2, such as IMSI in the TS of 3GPP.

CQI is an index indicating a wireless reception strength in each MS 5, and indicates, for example, that the smaller the value thereof is, the lower the reception strength is.

The weight value based on wireless communication quality of the BS 4 is a parameter indicating a weight value based on wireless communication quality of the BS 4 used for communication by a user when the user who is a congestion control target is selected. This value is determined by an operator, for example, based on his/her own congestion control policy, and a smaller value is set to a case which is desired to be excluded from a congestion control target. For example, a greater weight value is set in an MS 5 with a low wireless reception strength, and thereby an MS 5 with low wireless reception strength and low wireless communication quality is preferentially selected as a congestion control target such that the MS 5 in circumstances in which communication quality thereof is not good and connection is not performed well can be preferentially a congestion control target.

The congestion control target index for each user is a parameter used as an index indicating which user is preferentially selected as a congestion control target. For example, in the example of FIG. 11, the index is obtained using a product of CQI and Weight.

In addition, an initial value of the information included in the table 247 may be set in the GW 2 in advance, or may be set by a message which is received by the GW 2 from the PS 3 or the BS 4 or a command which is input by an operator. Further, this information may be updated by a message which is received by the GW 2 from the PS 3 or the BS 4 or a command which is input by the operator.

FIG. 12 shows the table 248 as an example of the information held in the memory unit 24 of the GW 2 according to the present embodiment. The table 248 indicates information for determining a selection type of congestion control target user and a method of performing congestion control when selected as a congestion control target for each call type and each service. FIG. 12 shows an example in which a single table 248 is held in the memory unit 24.

In addition, FIG. 21 shows another example of a table indicating information for determining a selection type of congestion control target user and a method of performing congestion control when selected as a congestion control target for each call type and each service. Further, as in FIG. 21, in a case where the tables 248 which are used for each congestion status are different, a plurality of tables 248 may be held in the memory unit 24. At this time, the respective tables 248 may be differentiated by the table names such as “Table 248#1” and “Table 248#2”.

The table 248 stores, for example, a call type (Call Type), an identifier of a service (Service ID), an upper limit value of the number of connected MSs (MS Num), a restricted bandwidth (BW), a selection type of congestion control target user (Type of MS Selection), and Precedence.

The identifiers of a call type and a service are the same parameters as the parameters included in the above-described table 241.

The upper limit value of the number of connected MSs is a parameter indicating an upper limit value of the number of MSs which are allowed to be connected to corresponding call type and service as a method of performing congestion control. The GW 2 releases a call connected to corresponding call type and service of an MS which has already been connected such that the number of MSs lies within the upper limit value of MSs which are allowed to be connected, according to a selection type of user who is a congestion control target described later, and determines whether or not new connection to the call type and the service is possible.

The restricted bandwidth is a parameter indicating an upper limit value of a bandwidth for each MS which is allowed to be connected to corresponding call type and service as a method of performing congestion control. The GW 2 performs bandwidth control on an MS of a user selected as a congestion control target so as to lie within the upper limit value of a bandwidth for each MS, prescribed by this parameter, according to a selection type of user who is the congestion control target described later.

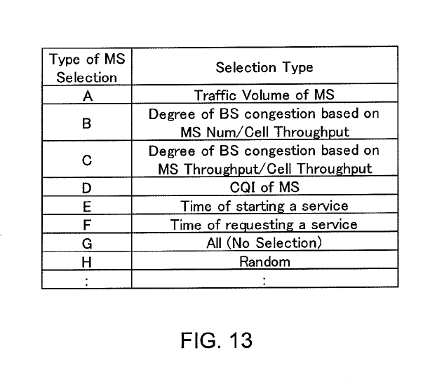

The selection type of congestion control target user is a parameter indicating a selection type (Selection Type), for example, as shown in FIG. 13. In the examples of FIGS. 12 and 13, A indicates a method based on a “communication traffic volume for each MS”; B indicates a method based on a “congestion degree of a BS based on a ratio of the number of MSs and a cell throughput”; C indicates a method based on a “congestion degree of a BS based on a ratio of a total transmission throughput of an MS and a cell throughput”; D indicates a method based on “wireless reception strength of an MS”; E indicates a method based on “time of starting a service”; F indicates a method based on “time of a request for starting a service”; G indicates a method of “targeting all MSs”; and H indicates a method of “randomly selecting an MS”. Details of A to F will be described later. G indicates a method of performing uniform congestion control on all MSs selected as congestion control target candidates. H indicates a method of randomly selecting an MS as a congestion control target among MSs selected as congestion control target candidates. Here, the random selection indicates round robin selection or the like through generation of random numbers.

Precedence is a parameter indicating an application order of which congestion control is preferentially performed in a case where a plurality of methods of performing congestion control are registered in the same call type and service. The GW 2 may employ a method of performing congestion control, for example, with a small value of Precedence, depending on a method of performing congestion control described later, in a call type and a service which are selected according to a selection type of call type and service which are congestion control targets described later. Here, for example, in a case where congestion is not removed any more even if congestion control is applied according to a method of performing congestion control of a value of certain Precedence, the GW 2 may apply a method of performing congestion control of the second smallest value of Precedence.

In addition, an initial value of the information included in the table 248 may be set in the GW 2 in advance, or may be set by a message which is received by the GW 2 from the PS 3 or the BS 4 or a command which is input by an operator. Further, this information may be updated by a message which is received by the GW 2 from the PS 3 or the BS 4 or a command which is input by the operator.

FIG. 14 shows the table 249 as an example of the information held in the memory unit 24 of the GW 2 according to the present embodiment. The table 249 indicates information of an MS connected to each call type and each service.

The table 249 stores, for example, a call type (Call Type), an identifier of a service (Service ID), and an identifier of an MS (MS ID).

The identifiers of a call type and a service are the same parameters as the parameters included in the above-described table 241.

The identifier of an MS is a parameter for identifying an MS connected to each call type and each service.

In addition, an initial value of the information included in the table 249 may be set in the GW 2 in advance, or may be set by a message which is received by the GW 2 from the PS 3 or the BS 4 or a command which is input by an operator. Further, this information may be updated by a message which is received by the GW 2 from the PS 3 or the BS 4 or a command which is input by the operator.

FIG. 17 shows the table 250 as an example of the information held in the memory unit 24 of the GW 2 according to the present embodiment. The table 250 indicates information for determining a congestion status on the basis of a threshold value of an allocated bandwidth sum value.

The table 250 stores, for example, a threshold value (Threshold) of an allocated bandwidth sum value, and a congestion status (Status).

The threshold value of an allocated bandwidth sum value is a parameter indicating a threshold value regarding a sum value of bandwidths allocated to each MS connected to the GW 2. A sum value of bandwidths allocated to each MS connected to the GW 2 may be obtained by summing a total allocated bandwidth for each call type and each service with respect to all call types and services, for example, in a case where the table 241 is managed as in FIG. 5.

The congestion status is a parameter for identifying each of a plurality of defined congestion statuses. For example, in a case where the table 250 is managed as shown in FIG. 17, a status in which a sum value of bandwidths allocated to the respective MSs connected to the GW 2 is “equal to or greater than 3000 Mbps and smaller than 4000 Mbps” is defined as a congestion status “Congestion#1”, a status in which a sum value of bandwidths allocated to the respective MSs connected to the GW 2 is “equal to or greater than 4000 Mbps and smaller than 4500 Mbps” is defined as a congestion status “Congestion#2”, and thereby the respective congestion statuses can be differentiated from each other.

In addition, an initial value of the information included in the table 250 may be set in the GW 2 in advance, or may be set by a message which is received by the GW 2 from the PS 3 or the BS 4 or a command which is input by an operator. Further, this information may be updated by a message which is received by the GW 2 from the PS 3 or the BS 4 or a command which is input by the operator.

FIG. 18 shows the table 251 as an example of the information held in the memory unit 24 of the GW 2 according to the present embodiment. The table 251 indicates information of a table for determining a selection type of congestion control target user and a method of performing congestion control when selected as a congestion control target for each congestion status.

The table 251 stores, for example, a congestion status (Status), and the type of table 248 to be used (Type of Table 248).

The congestion status is the same parameter as the parameter included in the above-described table 250.

The type of table 248 to be used is a parameter indicating which table 248 is applied for each congestion status. In addition, even if congestion statuses are different, the same table 248 may be used. Further, even a single table 248 may be applied.

In addition, an initial value of the information included in the table 251 may be set in the GW 2 in advance, or may be set by a message which is received by the GW 2 from the PS 3 or the BS 4 or a command which is input by an operator. Further, this information may be updated by a message which is received by the GW 2 from the PS 3 or the BS 4 or a command which is input by the operator.

FIG. 19 shows the table 252 as an example of the information held in the memory unit 24 of the GW 2 according to the present embodiment. The table 252 indicates information for determining a corresponding congestion status for each event of congestion occurrence or congestion foreseeing.

The table 252 stores, for example, the event (Event) of congestion occurrence or congestion foreseeing, and a congestion status (Status).

The event of congestion occurrence or congestion foreseeing is a parameter indicating the event of detecting a status in which congestion occurs or congestion is foreseen.

The congestion status is the same parameter as the parameter included in the above-described table 250.

In addition, an initial value of the information included in the table 252 may be set in the GW 2 in advance, or may be set by a message which is received by the GW 2 from the PS 3 or the BS 4 or a command which is input by an operator. Further, this information may be updated by a message which is received by the GW 2 from the PS 3 or the BS 4 or a command which is input by the operator.

As above, a description has been made of an example of the device configuration according to the present embodiment.

2. Process

2-1. Congestion Detecting Process

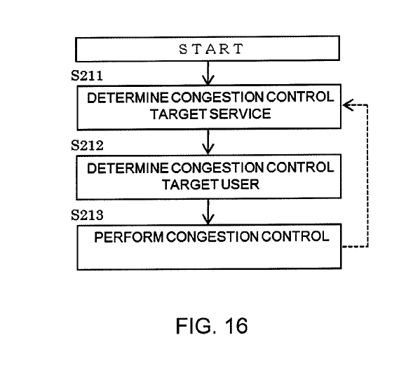

Next, a description will be made of an example of an operation process according to the present embodiment with reference to flowcharts of FIGS. 15 and 16.

Operation process: detection of congestion of GW 2 itself in GW 2

FIG. 15 shows an example of a congestion detecting process in which the GW 2 detects congestion of GW 2 itself according to the present embodiment.

In step S201, when a specific message is received using the SS interface unit 21, the BS interface unit 22, or the PS interface unit 23, the processing unit 25 of the GW 2 updates the table 241 held in the memory unit 24. Here, the specific message refers to, for example, a message indicating a request for connection of a new call, a message indicating deletion of an existing call, or a message indicating changing in a bandwidth allocated to an existing call. For example, in a case where the table 241 is managed as shown in FIG. 5, when a message indicating a request for connection of a new call is received, the processing unit 25 of the GW 2 compares an identifier of the SS 1 included in the message with an identifier of the SS 1 for emergency call held in the memory unit 24 so as to determine whether or not the call is an emergency call, and, if the call is not an emergency call, the processing unit 25 compares an identifier of the MS 5 included in the message with an identifier of the MS 5 for a preferential call held in the memory unit 24 so as to determine whether or not the call is a preferential call and which priority includes the user. In addition, the processing unit 25 of the GW 2 increases the number of MSs of corresponding call type and service by 1 on the basis of the correspondence relationship between an identifier of the service included in the message and the service name held in the memory unit 24. Here, the identifier of the SS 1 used to determine an emergency call uses, for example, Access Point Name (APN) in the TS of 3GPP, and the processing unit 25 of the GW 2 can discriminate an emergency call by determining whether or not the identifier is registered in the list (the table 253) of values indicating emergency agencies such as the police and the fire fighting, held in the memory unit 24. The list (the table 253) of identifiers of the SSs 1 indicating emergency agencies such as the police and the fire fighting may be set in the GW 2 in advance by an operator, or the list may be set in the PS 3 in advance by the operator and the GW 2 may acquire only a call type as a result of inquiring of the PS 3. The identifier of the MS 5 used to determine a preferential call uses, for example, International Mobile Subscriber Identity (IMSI) in the TS of 3GPP, and the processing unit 25 of the GW 2 can discriminate a preferential call by determining whether or not the identifier is registered in the list (the table 253) of values allocated to special terminals of government officials and the like, held in the memory unit 24. The list (the table 253) of identifiers of the MSs 5 allocated to special terminals of government officials and the like may be set in the GW 2 in advance by an operator, or the list may be set in the PS 3 in advance by the operator and the GW 2 may acquire only a call type as a result of inquiring of the PS 3. In addition, which priority includes the user of a normal call can be discriminated, for example, by the processing unit 25 of the GW 2 determining whether or not an identifier indicating the MS 5 which requests connection of a call is registered in a list (the table 253) of values allocated to normal terminals with a high priority such as a terminal for business use only or a subscriber of high price plan, held in the memory unit 24. The list (the table 253) of identifiers of the MSs 5 allocated to normal terminals with a high priority may be set in the GW 2 in advance by an operator, or the list may be set in the PS 3 in advance by the operator and the GW 2 may acquire only a call type as a result of inquiring of the PS 3. In addition, the identifier of the service included in the message uses, for example, QoS Class Identifier (QCI) in the TS of 3GPP, and can be obtained from the list (the table 253) indicating a correspondence relationship between QCI and a priority of the user, held in the memory unit 24. Here, the identifier of a service may be managed in a numerical value such as QCI, may be managed in the service name as in the example of FIG. 5, or may be managed in any character string. Further, in a case of a system in which the PS 3 determines a call type and a service, for example, the GW 2 may identify a call type and a service on the basis of information of the call type and the service which have been identified by the PS 3, included in a message received from the PS 3.

In step S202, the processing unit 25 of the GW 2 calculates a sum value of bandwidths allocated to calls connected to the GW 2 on the basis of the table 241 updated in step S201. For example, in a case where the table 241 is managed as shown in FIG. 5, the GW 2 calculates, for each service, a product of a bandwidth allocated to each service and the number of MSs connected to each service, so as to be stored as a total allocated bandwidth (Total BW) for each call type and each service. The GW 2 integrates the product calculated in this way for all the call types and services of the table 241 so as to be stored.

In step S203, the processing unit 25 of the GW 2 determines whether or not the sum value of the bandwidths allocated to calls connected to the GW 2, calculated in step S202, that is, the sum value of the total allocated bandwidths (Total BW) of the table 241 (FIG. 5) exceeds the threshold value managed in the table 250 of the memory unit 24. In addition, in a case where a plurality of threshold values are managed, the processing unit 25 of the GW 2 determines whether or not the sum value exceeds the smallest threshold value among the threshold values. This threshold value, for example, may be set in the GW 2 by an operator in advance, or may be changed to any value at any timing by the operator inputting a command, by a message from the PS 3, or the like. In addition, in a case where a congestion status of the GW 2 managed by the memory unit 24 of the GW 2 includes only two statuses, “congestion” and “congestion removal”, only a single threshold value may be managed in the table 250, and, in a case where a plurality of congestion statuses are managed by the memory unit 24 of the GW 2 depending on an extent or a factor of congestion, a plurality of threshold values may be registered in the table 250, for example, as shown in FIG. 17.

If the determination result in step S203 is “not equal to or greater than the threshold value”, the processing unit 25 of the GW 2 determines that the GW 2 is in a “congestion removal” status, records the fact that the GW 2 is in a “congestion removal” status in the memory unit 24 of the GW 2, and finishes this sequence in step S204N. An example of a process of the GW 2 in a “congestion removal” status will be described later.

If the determination result in step S203 is “equal to or greater than the threshold value”, the processing unit 25 of the GW 2 determines that the GW 2 is in a “congestion” status in step S204Y.

Here, the processing unit 25 of the GW 2 may further differentiate the “congestion” status for determination. Hereinafter, a description will be made of an example of a process in a case of performing specific determination of the “congestion” status.

The processing unit 25 of the GW 2 determines whether or not one or more values other than the value compared in step S203 are registered as threshold values managed in the table 250 of the memory unit 24.

If the determination result in step S204Y is that “there is no other managed threshold value”, the processing unit 25 of the GW 2 determines that the GW 2 is in a “congestion” status, acquires a congestion status corresponding to the threshold value compared in step S203 on the basis of the table 250, records the fact that the GW 2 is in a corresponding “congestion” status in an appropriate storage area of the memory unit 24 of the GW 2, and finishes this sequence. An example of a process of the GW 2 in the “congestion” status will be described later.

If the determination result in step S204Y is that “other managed threshold values are one or more”, the processing unit 25 of the GW 2 acquires the smallest threshold value among threshold values excluding the threshold value compared in step S203 in the threshold values managed in the table 250 of the memory unit 24, and determines whether or not the sum value of the bandwidths allocated to calls connected to the GW 2, calculated in step S202, exceeds the threshold value. The processing unit 25 of the GW 2 acquires the threshold values in the descending order among the threshold values excluding the threshold value compared in step S203 in the threshold values managed in the table 250 and continuously determines that the sum value exceeds the threshold value until it is determined that the sum value of the bandwidths allocated to calls connected to the GW 2, calculated in step S202, is equal to or smaller than the threshold value acquired from the table 250. If it is determined that the sum value of the bandwidths allocated to calls connected to the GW 2, calculated in step S202, is equal to or smaller than the threshold value, a congestion status corresponding to a threshold value which the sum value is determined as being exceeding lastly is acquired based on the table 250, the fact that the GW 2 is in the corresponding “congestion” status is recorded in an appropriate storage area of the memory unit 24 of the GW 2, and this sequence finishes. In addition, if the sum value of the bandwidths allocated to calls connected to the GW 2, calculated in step S202, exceeds the maximum threshold value managed in the table 250, a congestion status corresponding to the maximum threshold value is acquired based on the table 250, the fact that the GW 2 is in the corresponding “congestion” status is recorded in an appropriate storage area of the memory unit 24 of the GW 2, and this sequence finishes. An example of a process of the GW 2 in the “congestion” status will be described later.

For example, in a case where the table 250 is managed as in the example shown in FIG. 17, if the sum value of the bandwidths allocated to calls connected to the GW 2, calculated in step S202, is compared with “3000 Mbps” which is the minimum threshold value managed in the table 250, and, as a result, the sum value is “smaller than 3000 Mbps”, it is determined that the GW 2 is in a “congestion removal” status. In addition, if the calculated sum value of the bandwidths is “equal to or greater than 3000 Mbps and smaller than 4000 Mbps”, it is determined that the GW 2 is in a “congestion” status, and “Congestion#1” corresponding to the threshold value “3000 Mbps” which the sum value is determined as exceeding lastly is recorded as a corresponding congestion status. Examples of processes of the GW 2 of the “congestion removal” status and the “congestion” status will be respectively described later.

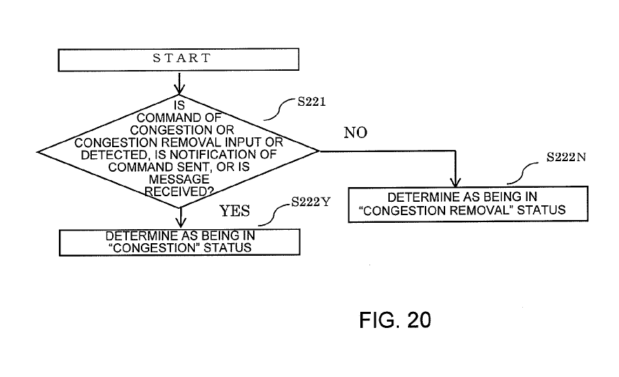

FIG. 20 is a diagram illustrating another example of a congestion detecting process in which the GW detects congestion of the GW itself according to the first embodiment.

In addition, as shown in FIG. 20, the GW 2 may detect congestion thereof in a method different from the method of the GW 2 detecting congestion thereof shown in FIG. 15 (S221 and S222Y). For example, there may be a function of inputting a command indicating congestion of the GW 2 from a maintenance and management device connected to the GW 2, or there may be a function of an operator who has detected congestion of the GW 2 manually notifying the GW 2 of the congestion.

Further, the GW 2 may detect congestion removal thereof in a method different from the method of the GW 2 detecting congestion thereof shown in FIG. 15 (S221 and S222N). For example, there may be a function of inputting a command indicating congestion removal of the GW 2 from a maintenance and management device connected to the GW 2, or there may be a function of an operator who has detected congestion removal of the GW 2 manually notifying the GW 2 of the congestion removal.

In addition, in the congestion detection function of the GW 2 itself, even in a case where congestion has not occurred yet actually, congestion may be foreseen, for example, based on reception of a message including a forecast regarding a disaster such as an earthquake, a tsunami, or a typhoon, or information in which congestion is foreseen such as a temporary traffic increase of a mail service during the New Year's holiday, or inputting of a command by an operator, or reception of a message indicating that a scheduled bandwidth or communication traffic volume becomes close to a value used as a reference of congestion or tends to increase, or inputting of a command by an operator (S221 and S222Y). The foreseeing of congestion may be differentiated from actual congestion, or may be treated as the same congestion.

For example, in a case where a correspondence relationship between a congestion status of the GW 2 and a congestion detection event is managed as in the table 252 shown in FIG. 19, if a “tsunami forecast (Tsunami Warning)” is detected, the processing unit 25 of the GW 2 may determine that a congestion status is “Congestion#1” on the basis of the table 252, record the corresponding congestion status in the memory unit 24, and perform a “congestion” status process described later. In addition, for example, an operator may manually input the corresponding congestion status to the GW 2.

Further, the GW 2 may cancel the foreseeing of congestion on the basis of reception of a message indicating that the foreseeing of congestion is canceled, or inputting of a command by an operator (S221 and S222N). As an example of a process in a case where the foreseeing of congestion is canceled, for example, the same process as the process of the GW 2 in a “congestion removal” status may be performed. An example of a process of the GW 2 in the “congestion removal” status will be described later.

Operation process: detection of congestion and congestion removal of devices other than GW 2 itself in GW 2

Hereinafter, a description will be made of an example of a process in which the GW 2 detects congestion and congestion removal of devices other than the GW 2 itself. A process flow is the same as the flow of FIG. 20, and thus description thereof will be omitted.

The GW 2 may detect congestion of other devices such as the SS 1, the PS 3, and the BS 4 connected to the GW 2, or may detect congestion of other devices which are not connected to the GW 2 via the SS 1, the PS 3, the BS 4, or the like connected to the GW 2, by using the function of the processing unit 25 detecting congestion of the system (S221 and S222Y). Here, the function of detecting congestion of the system may be, for example, a function of receiving a message indicating congestion of the system from an opposite node, a function of inputting a command indicating congestion of the system from a maintenance and management device connected to the GW 2 and an opposite node, a function of detecting congestion or failures of an opposite node since a packet is not received from the opposite node for a predetermined time or more, a function of detecting congestion or failures of an opposite node since a response message to a message transmitted to the opposite node is not returned for a predetermined time or more, or a function of an operator which has detected congestion of other devices manually notifying the GW 2 of the congestion of the system. The GW 2 may hold the detected congestion status of other devices in the memory unit 24. In addition, when a notification of congestion of other devices is sent, and when a notification of a target value of congestion control is sent, the GW 2 may hold the target value of congestion control along with the congestion status of other devices. Here, the target value of congestion control indicates information including an identifier of a congested device and the maximum value of total bandwidths of calls passing through the device. At this time, for example, in a process of the GW 2 in a “congestion” status described later, when a congestion control target user is determined in step S212, the GW 2 may select an MS having a call connected to the congestion device as a congestion control target, in preference to the result of “Type of MS Selection” determined based on the table 248. A list (the table 253) of MSs having a call connected to the congestion device may be held in the memory unit 24, may be manually input to the GW 2 by an operator which detects congestion of other devices, or may be acquired via the SS 1, the PS 3, the BS 4, or the like connected to the GW 2.

In addition, the GW 2 may detect congestion removal of other devices such as the SS 1, the PS 3, and the BS 4 connected to the GW 2, or may detect congestion removal of other devices which are not connected to the GW 2 via the SS 1, the PS 3, the BS 4, or the like connected to the GW 2, by using the function of the processing unit 25 detecting congestion of the system (S221 and S222N). The function of detecting congestion removal of the system may be, for example, a function of receiving a message indicating congestion removal of the system from an opposite node, a function of inputting a command indicating congestion removal of the system from a maintenance and management device connected to the GW 2 and an opposite node, a function of detecting that congestion or failures of an opposite node is removed since a packet is received from the opposite node, a function of detecting that congestion or failures of an opposite node are removed since a response message to a message transmitted to the opposite node is returned or from information included in the return message, or a function of an operator which has detected congestion removal of other devices manually notifying the GW 2 of the congestion removal of the system. The GW 2 may hold the detected congestion removal status of other devices in the memory unit 24. At this time, for example, the GW 2 may be operated according to a process of the GW 2 in a “congestion removal” status described later.

In addition, in the function of the processing unit 25 of the GW 2 detecting congestion of the system, even in a case where congestion has not occurred yet actually, congestion may be foreseen, for example, based on reception of a message including a forecast regarding a disaster such as an earthquake, a tsunami, or a typhoon, or information in which congestion is foreseen such as an temporary traffic increase of a mail service during the New Year's holiday, or inputting of a command by an operator, or reception of a message indicating that a scheduled bandwidth or communication traffic volume becomes close to a value used as a reference of congestion or tends to increase, or inputting of a command by an operator. The foreseeing of congestion may be differentiated from actual congestion, or may be treated as the same congestion in the GW 2 (S221 and S222Y). Further, the GW 2 may cancel the foreseeing of congestion on the basis of reception of a message indicating that the foreseeing of congestion is canceled, or inputting of a command by an operator (S221 and S222N). The GW 2 may hold the detected congestion foreseeing status of other devices in the memory unit 24.

For example, in a case where a correspondence relationship between a congestion status of the GW 2 and a congestion detection event is managed as in the table 252 shown in FIG. 19, if a “tsunami forecast (Tsunami Warning)” is detected, the processing unit 25 of the GW 2 may determine that a congestion status is “Congestion#1” on the basis of the table 252, record the corresponding congestion status in the memory unit 24, and perform a “congestion” status process described later. In addition, for example, an operator may manually input the corresponding congestion status to the GW 2. At this time, for example, in a process of the GW 2 in a “congestion” status described later, when a congestion control target user is determined in step S212, an MS having a call connected to the congestion device may be selected as a congestion control target, in preference to the result of “Type of MS Selection” determined based on the table 248. A list (the table 253) of MSs having a call connected to the congestion device may be held in the memory unit 24, may be manually input to the GW 2 by an operator which detects congestion of other devices, or may be acquired via the SS 1, the PS 3, the BS 4, or the like connected to the GW 2.

2.2 Congestion Control

Operation process: selection of call which is congestion control target and execution of congestion control in GW 2

FIG. 16 is a diagram illustrating an example of a process in which the GW 2 selects a congestion control target call and performs congestion control according to the present embodiment. Here, a description will be made of a process in a case where congestion of the GW 2 itself is detected through the above-described detection of congestion in the GW 2. In a case where the processing unit 25 of the GW 2 detects congestion of devices other than the GW 2 itself on the basis of the above-described method of detecting congestion and congestion removal of devices other than the GW 2 itself, for example, the processing unit 25 may select only calls passing through the corresponding device as calls of congestion control target candidates, and select a congestion control target call in the same method as an example of the selection process of a call which is a congestion control target among them. In this case, if congestion of devices other than the GW 2 is not detected, all calls connected to the GW 2 are selected as calls of congestion control target candidates. In addition, a process when congestion of the GW 2 itself is foreseen through the above-described detection of congestion in the GW 2 may be performed in the same manner as this process.

In step S211, the processing unit 25 of the GW 2 calculates a congestion control target selection index for each call type and each service on the basis of the table 242 held in the memory unit 24, and determines a call type and a service which are congestion control targets.

For example, in a case where the table 242 is managed as shown in FIG. 6, the processing unit 25 of the GW 2 calculates a congestion control target selection index for each service by using a product of a current total number of MSs connected for each call type and each service, acquired from the table 241 held in the memory unit 24, and the weight value based on characteristics for each call type and each service, set in the table 242 in advance, so as to be stored. In addition, the processing unit 25 of the GW 2 preferentially selects a service with the greatest index value as a congestion control target. In addition, in the example of FIG. 6, “Normal (Priority=Low), Game” is selected.

In step S212, the processing unit 25 of the GW 2 calculates a congestion control target selection index for each user on the basis of the table 243 held in the memory unit 24, and determines a user which is a congestion control target. A description thereof will be made in detail below.

For example, in a case where the table 248 is managed as shown in FIG. 12, the processing unit 25 of the GW 2 determines a selection type of a congestion control target user corresponding to a call type and a service which are selected as congestion control targets on the basis of the table 248 held in the memory unit 24. In this case, the processing unit 25 of the GW 2 acquires a selection type of the congestion control target user corresponding to the call type and the service selected as congestion control targets in step S211 from the table 248, and selects an MS which is a congestion control target among MSs connected to the service on the basis of the method. In this example, among data items of “Normal (Priority=Low), Game”, “A” of which Precedence is No. 1 is determined.

Here, when a selection type of a congestion control target user is managed as shown in FIG. 13, a case where an MS which is a congestion control target is determined based on a “communication traffic volume for each MS” designated by “A” will be described as an example. Methods other than “A” in FIG. 13, that is, an example of a calculation method of a weight value based on wireless communication circumstances of each MS, a connection start time of each MS, or the like will be described later. A weight value calculated in the an example described later can be used as a final congestion control target selection index for each user, for example, by taking a product with a congestion control target selection index for each user, calculated based on the table 243.

For example, in a case where the table 249 is managed as shown in FIG. 14, the processing unit 25 of the GW 2 extracts an identifier (s) of one or a plurality of MSs connected to the call type and the service selected in step S211. In this example, MS#1, MS#3, . . . are extracted among data items of Normal (Priority=Low), Game.

In addition, in a case where the table 243 is managed as shown in FIG. 7, the processing unit 25 of the GW 2 calculates a congestion control target selection index for each user by using a product of a product of a product of the number of transmitted UL packets, the number of transmitted UL bytes, the number of transmitted DL packets, and the number of transmitted DL bytes per second for each MS, measured by the processing unit 25 of the GW 2, and the weight value based on characteristics for each MS (user), with respect to MSs corresponding to the identifiers of the MSs extracted from the table 249, stores the values, and preferentially selects the user with the greatest value as a congestion control target. In this example, the index of MS#1 is 25000, the index of MS#3 is 20000, and thus MS#1 is selected. Here, the number of bytes of a packet may be, for example, the number of bytes of an entire packet or the number of bytes of only a length of a payload excluding a header portion. In addition, the number of transmitted UL packets, the number of transmitted UL bytes, the number of transmitted DL packets, and the number of transmitted DL bytes per second for each MS may be values regarding only a call type and a service selected in step S211 or may be a total amount which is not dependent on a call type and a service. Further, the number of transmitted UL packets, the number of transmitted UL bytes, the number of transmitted DL packets, and the number of transmitted DL bytes per second for each MS may use only some values for calculation of a congestion control target index for each user depending on a congestion control policy set by the operator.

In addition, for example, in a case where a plurality of tables 248 are managed according to congestion statuses as in the table 251 shown in FIG. 18, the processing unit 25 of the GW 2 may select a table 248 corresponding to a congestion status, held in the memory unit 24, on the basis of the table 250, and may use the table for the process in this step. At this time, a plurality of tables 248 including different setting contents may be managed for each type (“Table248#1” or the like) in the memory unit 24.

In step S213, the processing unit 25 of the GW 2 acquires a congestion control method corresponding to the call type and the service selected as a congestion control target in step S211 from the table 248, and performs congestion control on the user who is connected to the call type and the service selected as a congestion control target in step S211 and is selected as a congestion control target in step S212. In addition, the processing unit 25 of the GW 2 updates the table 241 (FIG. 5) according to an allocated bandwidth and/or the number of connected MSs of a call type and a service which have undergone congestion control. At this time, the processing unit 25 of the GW 2 updates the table 241, for example, by using the control bandwidth (BW) of the table 248 and/or the upper limit value of the number of connected MSs (MS Num).

Further, in a case where a target value of a bandwidth to be restricted becomes clear, the processing unit 25 of the GW 2 calculates, based on the table 241, a bandwidth reduced when further performing congestion control on the basis of the method, and thereby determines the number of users who are congestion control targets or a method performed as congestion control. Here, the target value of a bandwidth to be restricted may be, for example, set in the memory unit 24 of the GW 2 in advance, set in the GW 2 by an operator inputting a command or the like, or acquired by the GW 2 from the SS 1, the PS 3, or the BS 4. For example, in a case where a bandwidth of 20 Mbps is required to be reduced with respect to the target value, if a bandwidth of a service which secures a bandwidth of 0.1 Mbps per congestion control target MS is reduced to 0.06 Mbps per MS in a selected congestion control method, it can be seen that, when 500 MSs are selected as congestion control targets on the basis of 20/(0.1−0.06)=500, a bandwidth to be restricted arrives at the target value. Here, if the number of MSs which are congestion control target candidates connected to a service selected as a congestion control target is 500 or more, the processing unit 25 of the GW 2 may select 500 MSs on the basis of the selection type of the congestion control target user acquired from the table 248 so as to perform congestion control on the MSs. On the other hand, if the number of MSs which are congestion control target candidates connected to a service selected as a congestion control target is smaller than 500, the processing unit 25 of the GW 2 performs congestion control on all the MSs which are congestion control target candidates connected to the service selected as a congestion control target, and then performs a method with the second smallest value of Precedence in the same call type and service on the basis of the table 248. In a case where a bandwidth to be restricted does not arrive at the target value even if the processing unit 25 of the GW 2 performs the method with the greatest value of Precedence in the same call type and service, the processing unit 25 of the GW 2 returns to step S211, selects a call type and a service with the second greatest value of the congestion control target index on the basis of the table 242, and performs the method on the basis of the table 248. In the same manner for the following, the processing unit 25 of the GW 2 expands a control target in descending order of congestion control target index in relation to users and services selected as congestion control targets until a bandwidth to be restricted arrives at a target value.

On the other hand, even in a case where a target value of a bandwidth to be restricted does not become clear, for example, in the same manner as the case where the target value becomes clear, the processing unit 25 of the GW 2 may select a call which is a congestion control target and perform congestion control on the call, and expand a control target in ascending order of congestion control target indexes until congestion of a target device is removed. Here, in determination of whether or not a congestion control target is expanded, for example, the GW 2 may expand a control target in the events of detecting again a congestion status of a device of which congestion has been detected, by using the above-described congestion detecting function, after performing congestion control.

In addition, the processing unit 25 of the GW 2 may distribute time of performing congestion control according to a congestion control target selection index or characteristics such as the urgency of a service or a user.

Further, the processing unit 25 of the GW 2 may notify the SS 1, the PS 3, or the BS 4 of information of congestion of the GW 2. Furthermore, in a case where a notification of the information of congestion is sent, the processing unit 25 of the GW 2 may distribute timing of sending the notification according to a congestion control target index or characteristics such as the urgency of a service or a user.

Operation process: selection of congestion control target user based on wireless communication circumstances of each MS in GW 2

Hereinafter, a description will be made of an example of a selection process in which the GW 2 of the present embodiment selects a congestion control target user based on wireless communication circumstances of each MS. Here, a description will be made of a process in a case where congestion of the GW 2 itself is detected through the above-described detection of congestion in the GW 2. This process is performed in step S212 of FIG. 15. In addition, a process when congestion of the GW 2 itself is foreseen through the above-described detection of congestion in the GW 2 may be performed in the same manner as this process.

The processing unit 25 of the GW 2 calculates a congestion control target selection index for each MS depending on a determination condition of a weight value based on the wireless communication circumstances held in the memory unit 24, and determines a user which is a congestion control target.

The condition of the GW 2 determining a congestion control target selection index based on wireless communication quality of each MS held in the memory unit 24 may be managed, for example, as in the table 245 shown in FIG. 9. In this case, the processing unit 25 of the GW 2 may determine a corresponding congestion control target index for each BS on the basis of a ratio of a total transmission throughput of all MSs 5 connected to each BS 4, calculated from a cell throughput acquired from the BS 4 and the number of transmitted bytes for each MS 5 measured by the processing unit 25 of the GW 2, and the cell throughput. The processing unit 25 of the GW 2 may select an index as a congestion control target in descending order of the index. This case corresponds to a case where an MS which is a congestion control target is designated to “C” when a selection type of a congestion control target user is managed as shown in FIG. 13.

Alternatively, the determination condition of a congestion control target selection index based on wireless communication quality of each MS held in the memory unit 24 of the GW 2 may be managed, for example, as in the table 244 shown in FIG. 8. In this case, the processing unit 25 of the GW 2 may determine a corresponding congestion control target index for each BS on the basis of a ratio of a total number of all MSs 5 connected to each BS 4, calculated from a cell throughput acquired from the BS 4, and the cell throughput. The processing unit 25 of the GW 2 may select an index as a congestion control target in descending order of the index. This case corresponds to a case where an MS which is a congestion control target is designated to “B” when a selection type of a congestion control target user is managed as shown in FIG. 13.

In addition, in both the above-described cases, the processing unit 25 of the GW 2 may specify an identifier of the MS 5 connected to each BS 4, for example, on the basis of a correspondence relationship between an identifier of the BS 4 and an identifier of the MS 5 connected to the BS 4 managed in the table 246 shown in FIG. 10. The correspondence relationship of the table 246 may be updated in the events of the GW 2 receiving a position registration message or a handover message of the MS 5. Further, for example, the cell throughput of the BS 4 may be received from the BS 4 by the BS interface unit 22 of the GW 2, or may be acquired from a server (not shown) which holds statistical information acquired for the purpose of maintenance or the like.

In addition, the condition of the GW 2 determining a congestion control target selection index based on wireless communication quality of each MS held in the memory unit 24 may be managed, for example, as in the table 247 shown in FIG. 11. In this case, the processing unit 25 of the GW 2 may use an index of the reception strength of each MS acquired from the BS 4 as a congestion control target index. Here, the index of the reception strength of the terminal refers to, for example, Channel Quality Indicator (CQI) or a weight value (Weight) in the TS of 3GPP. The processing unit 25 of the GW 2 may select an index as a congestion control target, for example, in descending order of the index. This case corresponds to a case where an MS which is a congestion control target is designated to “D” when a selection type of a congestion control target user is managed as shown in FIG. 13.

Operation process: selection of congestion control target user based on connection start time of each MS in GW 2

Hereinafter, a description will be made of an example of a selection process in which the GW 2 of the present embodiment selects a congestion control target user based on a connection start time of each MS. Here, a description will be made of a process in a case where congestion of the GW 2 itself is detected through the above-described detection of congestion in the GW 2. This process is performed in step S212 of FIG. 15. In addition, a process when congestion of the GW 2 itself is foreseen through the above-described detection of congestion in the GW 2 may be performed in the same manner as this process.

The processing unit 25 of the GW 2 may determine a congestion control target index of each MS on the basis of a connection start time of each MS held in the memory unit 24. Here, for example, the connection start time of each MS may be time when the GW 2 receives a message for requesting connection to a service, or may be time when a UL packet or a DL packet used for each service is initially transmitted from the GW 2. The former case corresponds to a case where an MS which is a congestion control target is designated to “F”, and the latter case corresponds to a case where an MS which is a congestion control target is designated to “E”, when a selection type of a congestion control target user is managed as shown in FIG. 13.

Operation process: changing in determination condition of congestion control target call in GW 2

Hereinafter, a description will be made of an example of a process in which the GW 2 of the present embodiment changes a determination condition of a congestion control target call.

The determination condition of a congestion control target call applied in the GW 2 may be updated, for example, in the events of a determination condition of a congestion control target call held in the PS 3 being set and changed by an operator, or parameters which determine a congestion control target call, such as a wireless reception strength of the MS, a wireless communication standard, position information, or a congestion degree of the BS 4, being changed due to movement of the MS 5 or handover between other BSs 4. The changing process of the determination condition of a congestion control target call applied in the GW 2 may be performed, for example, by a node such as the PS 3, the BS 4, the MS 5, or the GW 2 which detects a change in a parameter used to determine a congestion control target call transmitting a message indicating the change to the GW 2 by using each interface unit.

In a case where the determination condition of a congestion control target call is changed, the processing unit 25 of the GW 2 may apply congestion control which is determined based on the changed determination condition of a congestion control target call to congestion which has already been detected, after the changing process is completed. Alternatively, the processing unit 25 of the GW 2 may apply a determination condition of a congestion control target call before being changed until congestion when the changing process is performed is removed, and may apply the changed determination condition of a congestion control target call to congestion which is detected from the next time.

In addition, in a case where the determination condition of a congestion control target call held in the GW 2 is changed, the GW 2 may transmit a message indicating the change to a node such as the PS 3, the BS 4, or the SS 1.

3. Congestion Control Canceling Process

Operation Process: Cancelation of Congestion Control in GW 2

Hereinafter, a description will be made of an example of a process in which the GW 2 of the present embodiment cancels congestion control. Here, a description will be made of a process in a case where congestion removal of the GW 2 itself is detected through the above-described detection of congestion in the GW 2. In a case where the processing unit 25 of the GW 2 detects congestion removal of devices other than the GW 2 on the basis of the above-described method of detecting congestion and congestion removal of the devices other than the GW 2 itself in the GW 2, the GW 2 may return to a state before the above-described process when the congestion of the devices other than the GW 2 is detected is applied. For example, the GW 2 may stop differentiating a call passing through a corresponding device and a call not passing through the device when selecting a call which is a congestion control target candidate, select a call which is a congestion control target in the same manner as in an example of the selection process of a call which is a congestion control target, and cancel the call.

For example, the processing unit 25 may select only calls passing through the corresponding device as calls of congestion control target candidates, and select a congestion control target call in the same method as an example of the selection process of a call which is a congestion control target among them. In this case, if congestion of devices other than the GW 2 is not detected, all calls connected to the GW 2 are selected as calls of congestion control target candidates. In addition, a process when congestion of the GW 2 itself is foreseen through the above-described detection of congestion in the GW 2 may be performed in the same manner as this process.

In a case where the GW 2 detects that the GW 2 is in a congestion removal status, if there is congestion control which is currently performed, the congestion control may be canceled.

For example, in a case where a target value of the maximum bandwidth which is allowed when the GW 2 is in a congestion removal status becomes clear, a bandwidth which increases when currently performed congestion control is canceled is calculated based on the table 241, so as to determine the number of users in which the congestion control is canceled or a method in which the congestion control is canceled. Here, the target value of a bandwidth may be, for example, set in the memory unit 24 of the GW 2 in advance, set in the GW 2 by an operator inputting a command or the like, or acquired by the GW 2 from the SS 1, the PS 3, or the BS 4. Further, a method of congestion control which is currently performed by the GW 2, or information which is required to cancel congestion control such as bandwidth restriction before the congestion control is performed, is assumed to be managed in the memory unit 24 of the GW 2. For example, in a case where a bandwidth of 20 Mbps may increase with respect to the target value, if a bandwidth of a service which secures a bandwidth of 0.1 Mbps per congestion control target MS is reduced to 0.06 Mbps per MS in a currently performed congestion control method, it can be seen that, when 500 MSs are canceled from congestion control targets on the basis of 20/(0.1-0.06)=500, a sum value of bandwidths is suppressed from being equal to or smaller than the target value. Here, if the number of MSs which are congestion control target candidates connected to a service selected as a congestion control target is 500 or more, 500 MSs which is selected as congestion control target and have a low priority on the basis of the selection type of the congestion control target user acquired from the table 248 so as to cancel congestion control. On the other hand, if the number of MSs which are congestion control target candidates connected to a service selected as a congestion control target is smaller than 500, the GW 2 cancels the congestion control on all the MSs which are congestion control target candidates connected to the service selected as a congestion control target, and then performs a method with the second greatest value of Precedence in the same call type and service on the basis of the table 248. In a case where a sum value of bandwidths is equal to or smaller than the target value even if the method with the smallest value of Precedence in the same call type and service is performed, and there is congestion control performed by the GW 2, the GW 2 selects a call type and a service with the second smallest value of the congestion control target index among call types and services on which the congestion control is in progress on the basis of the table 242, and performs the method on the basis of the table 248. In the same manner for the following, in a case where there is congestion control performed by the GW 2, and a sum value of bandwidths is equal to or smaller than the target value, a control target is expanded in ascending order of congestion control target index in relation to users and services selected as congestion control cancelation targets.

On the other hand, even in a case where a target value of a bandwidth does not become clear, for example, in the same manner as the case where the target value becomes clear, the minimum threshold value in the table 250 is set as a target value of a bandwidth, and the above-described congestion control canceling process may be performed.

In addition, the processing unit 25 of the GW 2 may distribute time of performing cancellation of congestion control according to a congestion control target selection index or characteristics such as the urgency of a service or a user. Thereby, for example, timing of canceling congestion control for rejecting call connection is distributed among the respective MSs, and thereby it is possible to prevent congestion from occurring again due to concentration of timing of re-connection requests from the respective MSs.

Further, the processing unit 25 of the GW 2 may notify the SS 1, the PS 3, or the BS 4 of information of congestion removal of the GW 2. Furthermore, in a case where a notification of the information removal of congestion is sent, the processing unit 25 of the GW 2 may distribute timing of sending the notification according to a congestion control target index or characteristics such as the urgency of a service or a user. Thereby, for example, timing of sending the notification of canceling congestion control for rejecting call connection is distributed among the respective MSs, and thereby it is possible to prevent congestion from occurring again due to concentration of timing of re-connection requests from the respective MSs.

4. Effects of Embodiment

In a wired or wireless communication system, in a case where a call which is a congestion control target is selected in the events of a communication device detecting congestion or congestion foreseeing of the communication system, it is possible to select a call which is a congestion control target on the basis of an occupied bandwidth or a communication traffic volume for each service or user in consideration of characteristics such as the urgency of the service or the user and to thereby reduce inequality between services or users in congestion control.

As is clear from the above description, the communication system according to the present embodiment is a wired or wireless communication system, and sets a condition for determining a call which is a congestion control target by using a value indicating a priority selected as a congestion control target and/or a bandwidth occupied by a service or a user when congestion occurs or a packet communication traffic volume, for example, on the basis of characteristics such as the urgency of the service or the user. Thereby, it is possible to provide a communication system and a communication device capable of reducing inequality between services or users in congestion control.

5. Supplementary Description

In addition, the present invention is not limited to the above-described embodiment and includes various modifications. The embodiment has been described in detail for better understanding of the present invention, and is not necessarily limited to including all the above-described constituent elements.

Further, the above-described respective configurations, functions, processing units, processing means, and the like may be realized in hardware, for example, by designing some or all of them using integrated circuits. In addition, information such as a program, a table, or a file realizing each function may be stored in a storage device such as a memory, a hard disk, or a Solid State Drive (SSD), or a recording medium such as an IC card or a DVD, or may be downloaded via a network or the like as necessary so as to be installed in various storage devices.

In addition, the present invention is applicable to a communication system which performs congestion control on an IP packet which is transmitted to and received from a wired or wireless terminal, and is applicable to various communication devices such as a GW, a PS, a BS, an MS, and an SS.

What is claimed is:

1. A communication system comprising:
a communication device that relays communication of a packet between a terminal device (MS) and other device, wherein
the communication device includes
a first table that stores an allocated bandwidth, the number of MSs, and a total allocated bandwidth for each call type and each service in relation to a plurality of calls connected to the communication device;
a second table that stores the number of connected MSs, a predefined weight value based on characteristics for each call type and each service, and a first index indicating a priority of a congestion control target, for each call type and each service in relation to a service which is selected as a congestion control target by the communication device; and
a processing unit that performs congestion control,
wherein
the processing unit receives a message indicating a connection request, or inputs a command regarding the congestion control, or detects a status or a failure regarding the congestion control,
the processing unit identifies a call type and a service by using the message, or the command, or the status or the failure, and increases the number of MSs of the call type and the service in the first table,
the processing unit calculates a total allocated bandwidth for each call type and each service by using a product of an allocated bandwidth and the number of MSs for each call type and each service on the basis of the first table, so as to be stored in the first table,
the processing unit refers to the first table and calculates a sum value by summing the total allocated bandwidth for a plurality of calls connected to the communication device, and determines whether or not the sum value exceeds a threshold value set in advance,
when the determination result is not equal to or not more than the threshold value, the processing unit determines that the communication device is in a congestion removal status, and, when the determination result is equal to or more than the threshold value, the processing unit determines that the communication device is in a congestion status,
the processing unit calculates the first index by using a product of the number of connected MSs and the weight value for each call type and each service on the basis of the second table, and preferentially selects a call type and a service as a congestion control target according to magnitude of the first index,
the processing unit preferentially performs the congestion control on one or a plurality of MSs corresponding to a call type and a service selected as a congestion control target, and
the processing unit obtains an allocated bandwidth and/or the number of MSs for each call type and each service from a result of performing the congestion control, and stores the allocated bandwidth and/or the number of MSs in the first table in correlation with the call type and the service.

2. The communication system according to claim 1, wherein
the communication device further includes:
a third table that stores an upper limit value of the number of connected MSs, a restricted bandwidth, and a selection type of one or a plurality of MSs of a congestion control target, for each call type and each service, and
the processing unit obtains a selection type corresponding to a call type and a service selected as a congestion control target by referring to the third table when performing the congestion control, and preferentially performs the congestion control on one or a plurality of MSs so as to fall in the upper limit value of the number of connected MSs and/or the restricted bandwidth according to the selection type.

3. The communication system according to claim 2, wherein
the selection type includes at least one of:
a method based on a “communication traffic volume for each MS”;
a method based on a “congestion degree of a base station (BS) based on a ratio of the number of MSs and a cell throughput”;
a method based on a “congestion degree of a BS based on a ratio of a total transmission throughput of an MS and a cell throughput”;
a method based on a “wireless reception strength of an MS”;
a method based on a “service start time”;
a method based on a “service start request time”;
a method of “targeting all MSs”;
a method of “randomly selecting an MS”;
a method of uniformly performing the congestion control on all MSs selected as the congestion control target candidates; and
a method of randomly selecting an MS which is a congestion control target among MSs selected as the congestion control target candidates, and
the processing unit performs the congestion control according to a method by any one of obtained selection types.

4. The communication system according to claim 2, wherein
the communication device further includes:
a fourth table that indicates an MS connected for each call type and each service, and
when the selection type of one or a plurality of MSs of a congestion control target is a method based on a “communication traffic volume for each MS”,
the processing unit preferentially performs the congestion control on one or a plurality of MSs corresponding to a connected call type and service.

5. The communication system according to claim 2, wherein
the communication device further includes:
a fifth table that stores, for each MS, a communication traffic volume, a predefined MS weight value based on characteristics for each MS, and a congestion control target index for each MS, and
when the selection type of one or a plurality of MSs of a congestion control target is a method based on a “communication traffic volume for each MS”,
the processing unit calculates the congestion control target index for each MS by using a product of a communication traffic volume for each MS measured by the processing unit and the MS weight value based on characteristics for each MS, and preferentially performs the congestion control on an MS with a great value of the index.

6. The communication system according to claim 2, wherein
the communication device further includes:
a sixth table that stores one or a plurality of MSs connected to a BS for each base station (BS) connected to the communication device; and
a seventh table that stores a predefined BS threshold value based on a congestion degree, and a predefined weight value based on a congestion degree of a BS, in relation to a BS connected to the communication device,
when a method by the selection type of one or a plurality of MSs of a congestion control target is a method based on a “congestion degree of a BS”,
the processing unit refers to the seventh table, compares a ratio of a total transmission throughput of a plurality of MSs connected to each BS and a cell throughput of the BS, or a ratio of the number of MSs connected to each BS and a cell throughput of the BS, with the BS threshold value so as to obtain a BS weight value, and specifies a BS with the great BS weight value, and
the processing unit refers to the sixth table and preferentially performs the congestion control on one or a plurality of MSs connected to the specified BS.

7. The communication system according to claim 2, wherein
the communication device further includes:
an eighth table that stores, for each MS, a wireless reception strength and/or an MS weight value based on wireless communication quality of a base station (BS), and a congestion control target index for each MS,
when a method by the selection type of one or a plurality of MSs of a congestion control target is a method based on a “wireless reception strength of an MS”,
the processing unit calculates a congestion control target index for each MS by using a product of a wireless reception strength of each MS acquired from a BS and the MS weight value, and preferentially performs the congestion control on an MS with a great value of the index.

8. The communication system according to claim 2, wherein, when a method by the selection type of one or a plurality of MSs of a congestion control target is a method based on a “service start time” or a “service start request time”,
the processing unit preferentially the congestion control on the basis of the service start time or the service start request time of each MS.

9. The communication system according to claim 2, wherein
the communication device further includes:
a ninth table that registers status threshold values for a plurality of status including a congestion removal status, a congestion foreseeing status, and a congestion status; and
the plurality of third tables corresponding to the statuses,
the processing unit compares the sum value obtained by summing the total allocated bandwidths with each of the status threshold values so as to determine a status, and
the processing unit performs the congestion control by referring to the third table corresponding to the determined status.

10. The communication system according to claim 2, wherein
the communication device further includes:
a tenth table that registers a congestion status and/or a status corresponding to a congestion detecting event; and
the plurality of third table corresponding to the statuses,
the processing unit determines a status according to the congestion status and/or detection of the congestion detecting event, and
the processing unit performs the congestion control by referring to the third table corresponding to the determined status.

11. The communication system according to claim 1, wherein
the processing unit includes at least one of:
a function of inputting or detecting a command indicating a congestion status or a congestion removal status of the communication device from a maintenance and management device of the communication device;
a function of receiving a message indicating a congestion status or a congestion removal status of the communication device;
a function of receiving a message or a command indicating a congestion status or a congestion removal status from an MS, an opposite node, or other device; and
a function of detecting a congestion status, a congestion removal status or a failure of the opposite node, wherein
the processing unit performs the congestion control by using at least one function.

12. The communication system according to claim 1, wherein, when a target value of a bandwidth to be restricted is predefined, the processing unit refers to the first table after the congestion control is performed and, when the target value is not achieved, repeatedly performs selection as the congestion control target, the congestion control, and storage in the first table.

13. The communication system according to claim 1, wherein the call type includes plural calls among an emergency call, a preferential call, a normal call with a high priority, a normal call with a low priority, and other type of call.

14. A communication device, which relays communication of a packet between a terminal device (MS) and other device, comprising:
a first table that stores an allocated bandwidth, the number of MSs, and a total allocated bandwidth for each call type and each service in relation to a plurality of calls connected to the communication device;
a second table that stores the number of connected MSs, a predefined weight value based on characteristics for each call type and each service, and a first index indicating a priority of a congestion control target, for each call type and each service in relation to a service which is selected as a congestion control target by the communication device; and
a processing unit that performs congestion control,
wherein
the processing unit receives a message indicating a connection request, or inputs a command regarding the congestion control, or detects a status or a failure regarding the congestion control,
the processing unit identifies a call type and a service by using the message, or the command, or the status or the failure, and increases the number of MSs of the call type and the service in the first table,
the processing unit calculates a total allocated bandwidth for each call type and each service by using a product of an allocated bandwidth and the number of MSs for each call type and each service on the basis of the first table, so as to be stored in the first table,
the processing unit refers to the first table and calculates a sum value by summing the total allocated bandwidth for a plurality of calls connected to the communication device, and determines whether or not the sum value exceeds a threshold value set in advance,
when the determination result is not equal to or not more than the threshold value, the processing unit determines that the communication device is in a congestion removal status, and, when the determination result is equal to or more than the threshold value, the processing unit determines that the communication device is in a congestion status,
the processing unit calculates the first index by using a product of the number of connected MSs and the weight value for each call type and each service on the basis of the second table, and preferentially selects a call type and a service as a congestion control target according to magnitude of the first index,
the processing unit preferentially performs the congestion control on one or a plurality of MSs corresponding to a call type and a service selected as a congestion control target, and
the processing unit obtains an allocated bandwidth and/or the number of MSs for each call type and each service from a result of performing the congestion control, and stores the allocated bandwidth and/or the number of MSs in the first table in correlation with the call type and the service.

15. A communication control method using a communication system which comprises a communication device that relays communication of a packet between a terminal device (MS) and other device, wherein
the communication device includes
a first table that stores an allocated bandwidth, the number of MSs, and a total allocated bandwidth for each call type and each service in relation to a plurality of calls connected to the communication device;
a second table that stores the number of connected MSs, a predefined weight value based on characteristics for each call type and each service, and a first index indicating a priority of a congestion control target, for each call type and each service in relation to a service which is selected as a congestion control target by the communication device; and
a processing unit that performs congestion control,
wherein
the processing unit receives a message indicating a connection request, or inputs a command regarding the congestion control, or detects a status or a failure regarding the congestion control,
the processing unit identifies a call type and a service by using the message, or the command, or the status or the failure, and increases the number of MSs of the call type and the service in the first table,
the processing unit calculates a total allocated bandwidth for each call type and each service by using a product of an allocated bandwidth and the number of MSs for each call type and each service on the basis of the first table, so as to be stored in the first table,
the processing unit refers to the first table and calculates a sum value by summing the total allocated bandwidth for a plurality of calls connected to the communication device, and determines whether or not the sum value exceeds a threshold value set in advance,
when the determination result is not equal to or not more than the threshold value, the processing unit determines that the communication device is in a congestion removal status, and, when the determination result is equal to or more than the threshold value, the processing unit determines that the communication device is in a congestion status,
the processing unit calculates the first index by using a product of the number of connected MSs and the weight value for each call type and each service on the basis of the second table, and preferentially selects a call type and a service as a congestion control target according to magnitude of the first index,
the processing unit preferentially performs the congestion control on one or a plurality of MSs corresponding to a call type and a service selected as a congestion control target, and
the processing unit obtains an allocated bandwidth and/or the number of MSs for each call type and each service from a result of performing the congestion control, and stores the allocated bandwidth and/or the number of MSs in the first table in correlation with the call type and the service.
